(19) United States
(12) Patent Application Publication
(10) Pub. No.: US 2011/0227817 A1
(43) Pub. Date: Sep. 22, 2011

(54) LIQUID CRYSTAL DISPLAY DEVICE AND METHOD FOR MANUFACTURING LIQUID CRYSTAL DISPLAY DEVICE TFT SUBSTRATE

(76) Inventor: Katsunori Misaki, Osaka-shi (JP)

(21) Appl. No.: 13/131,977

(22) PCT Filed: Nov. 19, 2009
(86) PCT No.: PCT/JP2009/006245

§ 371 Date: May 31, 2011

(30) Foreign Application Priority Data
Nov. 28, 2008 (JP) 2008-305677

(51) Int. Cl. G09G 3/36; B05D 5/12

(52) U.S. Cl. 345/92; 427/58

(57) ABSTRACT

A liquid crystal display device realizing a high display quality is provided at high production efficiency. A liquid crystal display device according to the present invention includes a reflective region and a transmissive region, and comprises a TFT substrate including a first transparent layer and a second transparent layer formed on a TFT and a pixel electrode formed on the first transparent layer or the second transparent layer; a counter substrate; and a liquid crystal layer. A first sub pixel electrode formed in the reflective region is formed on a surface of the second transparent layer; a second sub pixel electrode formed in the transmissive region is formed on a surface of the first transparent layer; and the second transparent layer includes a first elevated portion formed to protrude toward the liquid crystal layer more than the first sub pixel electrode and to surround each of the first and second sub pixel electrode.

### TECHNICAL FIELD

The present invention relates to a liquid crystal display device and a method for producing the same, and specifically to an active matrix type liquid crystal display device using a switching device such as a thin film transistor (TFT) or the like, and a method for producing the same.

### BACKGROUND ART

Recently, liquid crystal display devices are desired to have a higher level of performance. For mobile phones, mobile electronic devices and the like, the liquid crystal display devices are strongly desired to have lower power consumption and other performances more suitable to be used outdoor. For sufficiently meet such desires for performances, reflective liquid crystal display devices, which provide display by external light using photo-reflective pixel electrodes and so do not require light source devices, have been progressively developed.

In a TFT substrate of a reflective liquid crystal display device, pixel electrodes (reflective electrodes) are formed of a metal thin film having a high reflectance. The reflective liquid crystal display device allows natural light or light from an electric lamp incident from the display screen side to be reflected by the TFT substrate and uses the reflected light as a light source for liquid crystal display. The reflective electrodes have a rugged surface. The rugged surface of the reflective electrodes is obtained by forming the reflective electrodes on a photosensitive resin film having ruggedness on a surface thereof. By diffusely reflecting the light incident from the display screen side by the rugged surface of the reflective electrodes, a high-luminance, wide-viewing angle reflective liquid crystal display device is realized.

Patent Document 1 and Patent Document 2 describe examples of liquid crystal display devices which provide display using reflected light.

The liquid crystal display device described in Patent Document 1 includes a coloring layer and a multi-gap section on the pixel substrate side, and so prevents reduction in the numerical aperture and in the yield which would otherwise be caused by a shift in positional alignment of the pixel substrate and the counter substrate. In this liquid crystal display device, the multi-gap section, which is provided on the coloring layer, is formed so as to fill the opening, and a contact hole is formed inside the peripheral edge of the opening. Owing to this, the contact hole can be formed at the same time as the multi-gap, and so the number of production steps is decreased. In addition, the contact hole does not have a step between the coloring layer and the multi-gap section formed therein. This reduces the conductor failure of the transparent electrodes, and also improves the numerical aperture of display provided using the reflected light. Moreover, since the contact hole is provided in the opening, the reduction in the area size of the colored area which would otherwise be caused by an increase in the pixel density is prevented. As a result, display having high precision and high color saturation is made possible.

The liquid crystal display device described in Patent Document 2 is a reflective-transmissive liquid crystal display device, and includes a transmissive region and a reflective region which are provided for each pixel, a vertical alignment type liquid crystal layer provided between a pair of substrates, an inter-layer insulating film provided on one of the pair of substrates and having an opening, and a rivet provided in a central portion of the transmissive region in one of the pair of substrates. In the absence of a voltage, the alignment of liquid crystal molecules in the liquid crystal layer is regulated by the rivet and an inclining face of the inter-later insulating film. Therefore, a non-continuous area is made in which the orientation of the liquid crystal molecules aligned by the rivet and the orientation of the liquid crystal molecules aligned by the inclining face are non-continuous. The liquid crystal display device described in Patent Document 2 includes a light-blocking section for blocking light so that the light which has passed the non-continuous area does not reach the viewer.

In such a vertical alignment type liquid crystal display device including a transmissive region and a reflective region, it is desirable that the ratio of the cell gap (thickness of the liquid crystal layer) of the transmissive region and the cell gap of the reflective region is 2:1. Therefore, in general, a transparent resin layer called “white” is provided only in the reflective region to adjust the cell gap ratio to the above-mentioned ratio.

### CITATION LIST

### Patent Literature

Patent Document 1: Japanese Laid-Open Patent Publication No. 2006-30951

Patent Document 2: Japanese Laid-Open Patent Publication No. 2005-331926

### SUMMARY OF INVENTION

### Technical Problem

With reference to FIG. 12 through FIG. 16, an example of reflective-transmissive liquid crystal display device will be described. FIG. 12 is a plan view schematically showing a structure of one pixel of a reflective-transmissive liquid crystal display device 100. FIGS. 13(a) and (b) are respectively cross-sectional views showing structures of an A-A′ cross-section and a B-B′ cross-section of the liquid crystal display device 100 in FIG. 12. FIG. 14 through FIG. 16 are cross-sectional views showing a method for producing the liquid crystal display device 100.

The liquid crystal display device 100 includes a plurality of pixels 10 arranged in a matrix, a plurality of signal lines (drain bus lines) 12 extending in a longitudinal direction (up-down direction in FIG. 12) along borders between the pixels 10, and a plurality of scanning lines (gate bus lines) 14 extending in a transverse direction (left-right direction in FIG. 12) along borders between the pixels 10. As shown in FIG. 12, each of the pixels 10 is surrounded by two adjacent signal lines 12 and two adjacent scanning lines 14. The borders between the pixels 10 are on the center line of each of the signal lines 12 and each of the scanning lines 14.

The pixel 10 includes two transmissive regions 16 (an upper transmissive region is represented by 16a and a lower transmissive region is represented by 16b) and one reflective region 17 interposed between the two transmissive regions 16a and 16b. A pixel electrode 20 of the pixel 10 includes a sub pixel electrode 20a in the transmissive region 16a, a sub pixel electrode 20b in the transmissive region 16b, and a sub pixel electrode 20c in the reflective region 17. The sub pixel electrode 20a and the sub pixel electrode 20c are connected to each other with a part of the pixel electrode 20, and the sub pixel electrode 20b and the sub pixel electrode 20c are connected to each other with a part of the pixel electrode 20.

In the vicinity of an intersection of the signal line 12 and the scanning line 14 in a lower left part of the pixel 10, a TFT 18 is located. A gate electrode of the TFT 18 is connected to the scanning line 14, a drain electrode of the TFT 18 is connected to the signal line 12, and a source electrode of the TFT 18 is connected to the sub pixel electrode 20b. Below the reflective region 17 of the pixel electrode 10, a storage capacitance line (Cs line) 15 extends in the left-right direction. Between the storage capacitance line 15 and the sub pixel electrode 20c, a reflective layer 25 is formed. The reflective layer 25 is electrically connected to the source electrode of the TFT 18 and acts as an intermediate electrode. A part of the storage capacitance line 15 which is below the reflective layer (intermediate electrode) 25 acts as a storage capacitance electrode 15c, so that a storage capacitance of the pixel 10 is formed between the reflective layer 25 and the storage capacitance electrode 15c.

FIG. 13(a) is a cross-sectional view of the reflective region 17, and FIG. 13(b) is a cross-sectional view of the transmissive region 16a. As shown in FIG. 13, the liquid crystal display device 100 includes a TFT substrate 30, a counter substrate 40, and a liquid crystal layer 50 located between the TFT substrate 30 and the counter substrate 40. The liquid crystal layer 50 is a vertical alignment type liquid crystal layer containing liquid crystal molecules having a negative dielectric anisotropy.

The TFT substrate 30 includes a glass substrate 31, a gate insulating layer 32 formed on the glass substrate 31, a protective layer 33 formed on the gate insulating layer 32, a color filter (OF) 34 formed on the protective layer 33, and a transparent insulating layer (JAS) layer 35 formed on the color filter 34. In the reflective region 17, a transparent resin layer 36 is formed on the transparent insulating layer 35, and the sub pixel electrode 20c is formed on the transparent resin layer 36. In the transmissive regions 16a and 16b, the sub pixel electrodes 20a and 20b are respectively formed on the transparent insulating layer 35 without the transparent resin layer 36 being formed. By providing the transparent resin layer 36 only in the reflective region 17, the ratio of the cell gap of the transmissive region 16 and the cell gap of the reflective region 17 is set to 2:1.

In the reflective region 17, the storage capacitance electrode 15c is formed between the glass substrate 31 and the gate insulating layer 32, and the reflective layer 25 is formed between the gate insulating layer 32 and the protective layer 33. The reflective layer 25 has ruggedness for diffusively reflecting light. The ruggedness reflects an opening or a hollow formed in the storage capacitance electrode 15c below the reflective layer 25.

Between the gate insulating layer 32 and the protective layer 33, the TFT 18 shown in FIG. 12 is also formed. The TFT 18 includes an operative semiconductor layer included in a channel of the TFT 18 and formed of, for example, amorphous silicon (a-Si) and an ohmic contact layer formed of n⁺-Si. The ohmic contact layer is connected to the source electrode and the drain electrode, and the source electrode is electrically connected to the sub pixel electrode 20b located thereabove via a contact hole formed through the protective layer 33, the color filter 34 and the transparent insulating layer 35. The source electrode is also electrically connected to the reflective layer 25 in the reflective region 17. The reflective layer 25 is electrically connected to the sub pixel electrode 20c located thereabove via a contact hole formed through the protective layer 33, the color filter 34, the transparent insulating layer 35 and the transparent resin layer 36.

As shown in FIG. 12 and FIG. 13, an elevated portion (rib) 27 is formed around the transmissive regions 16a and 16b and the reflective region 17 so as to surround each of the sub pixel electrodes 20a, 20b and 20c. The elevated portion 27 has a function of aligning the liquid crystal molecules to be directed inward in each of the transmissive regions 16a and 16b and the reflective region 17.

The counter substrate 40 includes a glass substrate 41, a counter electrode 42 formed on the glass substrate 41 on the liquid crystal layer 50 side, and elevated portions 45 (45a, 45b and 45c) formed at three positions on a surface of the counter electrode 42, the surface facing the liquid crystal layer 50. The elevated portions 45a, 45b and 45c are formed above the central positions of the sub pixel electrodes 20a, 20b and 20c, respectively.

The cell gap of the reflective region 17 (the distance between the sub pixel electrode 20c and the counter electrode 42, or the thickness of the liquid crystal layer 50 between these electrodes) is, for example, 1.7 μm. The cell gap of the transmissive regions 16a and 16b (the distance between the sub pixel electrode 20a/20b and the counter electrode 42, or the thickness of the liquid crystal layer 50 between these electrodes) is, for example, 3.4 μm. As can be seen, the cell gap of the transmissive regions 16a and 16b is twice the cell gap of the reflective region 17.

The elevated portions 45a, 45b and 45c, together with the elevated portion 27 in the TFT substrate 30, act as alignment control means for aligning the liquid crystal molecules in the transmissive region 16a, the transmissive region 16b and the reflective region 17 radially around the elevated portions 45a, 45b and 45c as the center. The elevated portion 45c extends from the counter electrode 42 so as to contact the sub pixel electrode 20c and thus also acts as a spacer for keeping the cell gap at a certain level.

Now, with reference to FIG. 14 through FIG. 16, a method for producing the liquid crystal display device 100 will be described. FIGS. 14(a) through (e) and FIG. 15(f) through (i) are cross-sectional views showing a method for producing the TFT substrate 30 of the liquid crystal display device 100. FIGS. 16(a) and (b) are cross-sectional views showing a method for producing the counter substrate 40 of the liquid crystal display device 100. In each figure, the cross-sectional view of the reflective region 17 (corresponding to the A-A′ cross-section in FIG. 12) is shown on the left, and the cross-sectional view of the transmissive region 16a (corresponding to the B-B′ cross-section in FIG. 12) is shown on the right.

For producing the TFT substrate 30, first, on the entirety of a top surface of the glass substrate 31, which is a transparent insulating substrate, Al (aluminum) or an Al alloy is applied in a layer to a thickness of, for example, 130 nm by sputtering. When necessary, before the application, a protective layer of SiOₓ or the like may be formed on the top surface of the glass substrate 31. Next, on the applied Al or the like, Ti (titanium) or a titanium alloy is applied in a layer to a thickness of, for example, 70 nm by sputtering. Thus, a metal layer having a thickness of about 200 nm is formed. Instead of Ti, Cr (chromium), Mo (molybdenum), Ta (tantalum), W (tungsten) or an alloy thereof may be used. Instead of Al, a material containing one or a plurality of Nd (neodymium), Si (silicon), Cu (copper), Ti, W, Ta and Sc (scandium) may be used.

Then, a resist layer is formed on the metal layer and subjected to exposure using a first mask (photomask or reticle; hereinafter, referred to simply as the “mask”) to form a resist mask, and the metal layer is patterned by dry etching with a chlorine-based gas. Thus, as shown in FIG. 14(a), the storage capacitance electrode 15c is formed. At the same time, the scanning lines 14, the storage capacitance lines 15, and the gate electrode of the TFT 18 are formed. In this step, an opening or a hollow is formed in the storage capacitance electrode 15c.

Next, as shown in FIG. 14(b), a silicon nitride film (SiN), for example, is formed on the entire surface of the substrate to a thickness of about 400 nm by plasma CVD to obtain the gate insulating layer 32. Next, in order to form the operative semiconductor layer of the TFT 18, an amorphous silicon (a-Si) layer (not shown), for example, is stacked on the entire surface of the substrate to a thickness of about 30 nm by plasma CVD. In order to form a channel protective film (etching stopper) of the TFT 18, a silicon nitride film (SiN) (not shown), for example, is formed on the entire surface of the substrate to a thickness of about 150 nm by plasma CVD.

Next, a photoresist is applied on the entire surface of the substrate by spin-coating or the like, and then subjected to rear exposure from the glass substrate 31 side using the scanning lines 14, the storage capacitance line 15 and the storage capacitance electrode 15c as a mask. Then, the exposed resist layer is dissolved to form a resist pattern on the scanning lines 14, the storage capacitance line 15 and the storage capacitance electrode 15c in a self-aligned manner.

The resist pattern is further subjected to exposure using a second mask in a forward direction (from the side opposite to the glass substrate 31) to leave the resist layer only on an area in which the channel protective film is to be formed. Then, the silicon nitride film is dry-etched with a fluorine-based gas using the resist layer as a mask to form the channel protective film. As shown in FIG. 14(b), the channel protective film is not provided above the storage capacitance electrode 15c.

Next, the surface of the amorphous silicon layer is washed using diluted hydrogen fluoride to remove the oxide film. Then, in order to form the ohmic contact layer of the TFT 18, n⁺a-Si, for example, is applied in a layer promptly on the entire surface of the substrate to a thickness of about 30 nm by plasma CVD. Next, an Al layer (or an Al alloy layer), for example, and a high melting point metal layer of Ti or a Ti alloy are stacked to respective thicknesses of 100 nm and 80 nm by sputtering to obtain a conductive layer. The conductive layer is used to form the reflective layer 25 acting as one of a pair of electrodes (acting as the intermediate electrode) for forming a storage capacitance (accumulation capacitance) and also used to form the drain electrode and the source electrode of the TFT 18. For the high melting point metal layer, Cr, Mo, Ta, W or an alloy thereof may also be used.

Next, a photoresist layer is formed on the entire surface of the substrate, and the resist is subjected to exposure using a third mask. Then, the resist layer is patterned by development. Using the patterned resist layer as an etching mask, dry etching is performed on the conductive layer, the n⁺a-Si layer and the amorphous silicon layer with a chlorine-based gas. Thus, the reflective layer 25 as shown in FIG. 14(c) is obtained, and at the same time, the signal lines 12, and the drain electrode, the source electrode, the ohmic layer and the operative semiconductor layer of the TFT 18 are formed. During the etching treatment, the channel protective film acts as an etching stopper. Therefore, the amorphous silicon layer in the channel region is left without being etched away, and so a desired operative semiconductor layer is formed.

Next, as shown in FIG. 14(d), a silicon nitride film (SiN), for example, is formed on the entire surface of the substrate to a thickness of about 300 nm by plasma CVD to form the protective layer 33.

Next, as shown in FIG. 14(e), the color filters 34 of R (red), G (green) and B (blue) resins are formed for R, G and B pixels by photolithography. In this step, among the plurality of pixels arranged in a matrix, the pixels of the same column are provided with the color filters 34 of the same color.

In this step, first, for example, an acrylic negative photosensitive resin containing a red (R) pigment (red resin) is applied on the entire surface of the substrate to a thickness of, for example, 170 nm by a spin-coater, a slit-coater or the like. Next, proximity exposure is performed using a fourth mask so that the resin is left in stripes corresponding to a prescribed plurality of columns of pixels. Next, development is performed using an alkaline developer of KOH (potassium hydroxide) or the like to form the color filters 34 of the red resin. Thus, the red pixels are each provided with red spectroscopic characteristics and also a light-blocking function of preventing external light from being incident on the TFT 18.

In a similar manner, an acrylic negative photosensitive resin having a blue (B) pigment dispersed therein (blue resin) is applied and is patterned using a fifth mask to form the color filters 34 of the blue resin for columns of pixels different from the red pixels. Thus, the blue pixels are each provided with blue spectroscopic characteristics and also a light-blocking function of preventing external light from being incident on the TFT 18.

Furthermore, an acrylic negative photosensitive resin having a green (G) pigment dispersed therein (green resin) is applied and is patterned using a sixth mask to form the color filters 34 of the green resin for columns of pixels between the columns of red pixels and the columns of blue pixels. Thus, the green pixels are each provided with green spectroscopic characteristics and also a light-blocking function of preventing external light from being incident on the TFT 18.

In the step of forming the color filters 34, a contact hole for electrically connecting the drain electrode of the TFT 18 to the layer thereabove is formed in each color filter 34.

Next, as shown in FIG. 15(f), a transparent insulating resin is applied on the entire surface of the substrate by a spin-coater, a slit-coater or the like, and is heated at a temperature of 140° C. or lower. The transparent insulating resin used in this step is an acrylic resin having a negative photosensitivity. Next, the transparent insulating resin is subjected to proximity exposure using a seventh mask and developed using an alkaline developer of KOH or the like to form the transparent insulating layer 35.

In this step, a contact hole for electrically connecting the drain electrode of the TFT 18 to the layer thereabove is formed in the transparent insulating layer 35, above the contact hole formed in the color filter 34. In the contact hole, the protective layer 33 is exposed. Contact holes are also formed in at least an area where terminals are to be formed and an area where electrodes are to be connected. In these contact holes, the gate insulating layer 32 or the protective layer 33 is exposed. Next, dry etching is performed with a fluorine-based gas using the transparent insulating layer 35 as a mask to remove a part of the protective layer 33 and a part of the gate insulating layer 32 which are below the contact holes.

Next, a transparent acrylic resin is applied on the entire surface of the substrate by a spin-coater, a slit-coater or the like, and is heated at a temperature of 140° C. or lower. The transparent acrylic resin used in this step is an acrylic resin having a negative photosensitivity. The transparent acrylic resin is subjected to proximity exposure using an eighth mask and developed using an alkaline developer of KOH or the like to form the transparent resin layer 36 as shown in FIG. 15(g). The transparent resin layer 36 is formed in the reflective region 17 or above the storage capacitance line 15 in FIG. 12, and extends in stripes in the left-right direction. The transparent resin layer 36 is not formed in the transmissive region 16a or 16b.

Next, ITO (indium thin oxide), which is a transparent oxide conductive material, is applied in a layer on the entire surface of the substrate to a thickness of 70 nm by a thin film formation technique such as sputtering or the like. Then, a resist mask having a prescribed pattern is formed using a ninth mask, and ITO is wet-etched with an oxalic acid-based etchant to obtain the pixel electrodes 20 as shown in FIG. 15(h). The sub pixel electrodes 20a, 20b and 20c included in the pixel electrode 20 are electrically connected to each other with a part of the pixel electrode 20. The sub pixel electrode 20b included in the pixel electrode 20 is electrically connected to the source electrode of the TFT 18 and the reflective layer (intermediate electrode) 25 via the contact holes. After the pixel electrode 20 is formed, the substrate is heated at a temperature in the range of 150 to 230° C., preferably at a temperature of 200° C.

Next, a transparent acrylic resin is applied on the entire surface of the substrate by a spin-coater, a slit-coater or the like, and is heated at a temperature of 140° C. or lower. The transparent acrylic resin used in this step is an acrylic resin having a negative photosensitivity. Next, the transparent acrylic resin is subjected to proximity exposure using a 10th mask and developed using an alkaline developer of KOH or the like to form the elevated portion (rib) 27 as shown in FIG. 15(i). As shown in FIG. 12, the elevated portion 27 is formed at the border between adjacent pixels 10 and at the borders between the transmissive regions 16 and the reflective region 17, so as to surround each of the sub pixel electrodes 20a, 20b and 20c.

Now, with reference to FIG. 16, a method for producing the counter substrate 40 will be described.

First, on the entirety of a surface of the glass substrate 41, which is a transparent insulating substrate, ITO, which is a transparent oxide conductive material, for example, is directly applied in a layer to a thickness of 100 nm by sputtering or the like. Thus, as shown in FIG. 16(a), the counter electrode 42 of ITO is formed.

Next, a transparent acrylic resin is applied on the entirety of a top surface of the counter electrode 42 by a spin-coater, a slit-coater or the like, and is heated at a temperature of 140° C. or lower. The transparent acrylic resin used in this step is an acrylic resin having a negative photosensitivity. Next, the transparent insulating resin is subjected to proximity exposure using an 11th mask and developed using an alkaline developer of KOH or the like to form the elevated portions (ribs) 45a and 45c as shown in FIG. 16(b). At the same time, the elevated portion 45b shown in FIG. 12 is also formed. The elevated portions 45a, 45b and 45c are respectively located approximately at the centers of the sub pixel electrodes 20a, 20b and 20c.

The liquid crystal display device 100 formed in this manner can stably align the liquid crystal molecules radially in each of the transmissive region 16a, the transmissive region 16b and the reflective region 17 by means of the elevated portions 27, 45a, 45b and 45c, and so can provide display with a high response speed and superb viewing angle characteristics. In addition, owing to ruggedness reflecting the shape of the storage capacitance electrode 15c which is formed in the reflective layer 25 in the reflection area 17, the liquid crystal display device 100 can reflect the reflected light diffusely and so can provide high viewing angle characteristics.

However, as described above, the production of the liquid crystal display device 100 requires a relatively large number of masks of 11 in total and formation steps corresponding to the respective masks.

An object of the present invention is to produce a liquid crystal display device providing a high response speed and good viewing angle characteristics with a relatively small number of production steps at a high production efficiency.

### Solution to Problem

A liquid crystal display device according to the present invention is a liquid crystal display device including a plurality of pixels each having a reflective region for providing display by reflecting light incident from a display plane side and a transmissive region for providing display by transmitting light incident from a side opposite to the display plane side, and comprises a TFT substrate including a TFT located for each of the plurality of pixels, a first transparent layer and a second transparent layer formed on the TFT, and a pixel electrode formed on the first transparent layer or the second transparent layer; a counter substrate including a counter electrode facing the pixel electrode; and a liquid crystal layer located between the TFT substrate and the counter substrate. The pixel electrode includes a first sub pixel electrode formed in the reflective region and a second sub pixel electrode formed in the transmissive region; the first sub pixel electrode is formed on a surface of the second transparent layer, the surface facing the liquid crystal layer; the second sub pixel electrode is formed on a surface of the first transparent layer, the surface facing the liquid crystal layer; and the second transparent layer includes a first elevated portion which is formed to protrude toward the liquid crystal layer more than the first sub pixel electrode and to surround the first sub pixel electrode and the second sub pixel electrode.

In an embodiment, the TFT substrate includes a plurality of scanning lines for supplying the TFT with a gate signal and a plurality of signal lines for supplying the TFT with a display signal; the plurality of pixels are each located between two adjacent scanning lines among the plurality of scanning lines and two adjacent signal lines among the plurality of signal lines; and the first elevated portion is formed on the two adjacent scanning lines, on the two adjacent signal lines, and in an area between the first sub pixel electrode and the second sub pixel electrode.

In an embodiment, the first elevated portion is formed by the second transparent layer being stacked on the first transparent layer.

In an embodiment, the liquid crystal display device comprises a protective layer formed on the TFT and a color filter layer formed on the protective layer. The color filter layer has an opening or a hollow formed therein; a part of the first transparent layer is formed in the opening or the hollow; and the first elevated portion of the second transparent layer is formed above the opening or the hollow.

In an embodiment, the first elevated portion has a height of 0.5 μm or greater and 1.0 μm or less from a surface of the first sub pixel electrode to a surface of the first elevated portion, the surface of the first elevated portion facing the counter substrate.

In an embodiment, a second elevated portion reaching the TFT substrate is formed on a surface of the counter electrode in the reflective region; and a third elevated portion extending toward the TFT substrate is formed on the surface of the counter electrode in the transmissive region.

In an embodiment, the second elevated portion and the third elevated portion are respectively formed on centers of the first sub pixel electrode and the second sub pixel electrode.

In an embodiment, the second transparent layer in the reflective region includes a fourth elevated portion reaching the counter electrode; and the second transparent layer in the transmissive region includes a fifth elevated portion formed on the first transparent layer and reaching the counter substrate.

In an embodiment, the fourth elevated portion is formed by the second transparent layer being formed on the first transparent layer.

In an embodiment, the fourth elevated portion and the fifth elevated portion are respectively formed at central positions of the first sub pixel electrode and the second sub pixel electrode.

In an embodiment, the TFT substrate includes a storage capacitance line extending to pass the reflective region, and a reflective layer located between the storage capacitance line and the first sub pixel electrode; the pixel electrode and the reflective layer are electrically connected to each other; and a storage capacitance is formed between the storage capacitance line and the reflective layer.

In an embodiment, a part of the storage capacitance line, the part facing the reflective layer, has an opening or a hollow formed therein; and ruggedness reflecting the opening or the hollow of the storage capacitance line is formed in the reflective layer.

In an embodiment, the transmissive region includes a first transmissive region and a second transmissive region located so as to interpose the reflective region therebetween.

In an embodiment, the liquid crystal layer is a vertical alignment type liquid crystal layer containing liquid crystal molecules having a negative dielectric anisotropy.

A method according to the present invention is a method for producing a TFT substrate of a liquid crystal display device including a plurality of pixels each having a reflective region for providing display by reflecting light incident from a display plane side and a transmissive region for providing display by transmitting light incident from a side opposite to the display plane side, and comprises a first step of forming a TFT for each of the plurality of pixels; a second step of forming a first transparent layer after the first step; a third step of forming a second transparent layer after the second step; and a fourth step of forming a pixel electrode on the first transparent layer and the second transparent layer after the third step. In the third step, a first elevated portion extending to surround each of the reflective region and the transmissive region is formed in the second transmissive layer; and the fourth step includes a step of forming a first sub pixel electrode on the second transparent layer in the reflective region and a step of forming a second sub pixel electrode on the first transparent layer in the transmissive layer, and the first sub pixel electrode and the second sub pixel electrode are each formed to be surrounded by the first elevated portion.

In an embodiment, the method further comprises a step of forming a plurality of scanning lines for supplying the TFT with a gate signal and a step of forming a plurality of signal lines for supplying the TFT with a display signal. The plurality of pixels are each located between two adjacent scanning lines among the plurality of scanning lines and two adjacent signal lines among the plurality of signal lines; and in the third step, the first elevated portion is formed on the two adjacent scanning lines, on the two adjacent signal lines, and in an area between the reflective region and the transmissive region.

In an embodiment, in the third step, the first elevated portion is formed by stacking the second transparent layer on the first transparent layer.

In an embodiment, the method further comprises a step of forming a protective layer on the TFT and a step of forming a color filter having an opening or a hollow on the protective layer. In the second step, a part of the first transparent layer is formed in the opening or the hollow; and in the third step, the first elevated portion is formed by forming a part of the second transparent layer on the part of the first transparent layer.

In an embodiment, in the third step, a first central elevated portion protruding more than the first elevated portion in a central portion of the reflective region and a second central elevated portion protruding more than the first elevated portion in a central portion of the transmissive region are formed in the second transparent layer.

In an embodiment, in the third step, the first central elevated portion and the second central elevated portion are formed by forming the second transparent layer on the first transparent layer.

In an embodiment, in the step of forming the scanning lines, a storage capacitance line extending to pass the reflective region is formed; and in the step of forming the signal lines, a reflective layer is formed on the storage capacitance line.

In an embodiment, an opening or a hollow is formed in a part of the storage capacitance line; and ruggedness reflecting the opening or the hollow of the storage capacitance line is formed in the reflective layer.

In an embodiment, the TFT substrate is formed using nine or less photomasks.

### Advantageous Effects of Invention

According to the present invention, a liquid crystal display device having a high response speed and superb viewing angle characteristics can be provided efficiently.

### BRIEF DESCRIPTION OF DRAWINGS

FIG. 1 is a perspective view schematically showing a structure of a liquid crystal display device 101 in Embodiment 1 according to the present invention.

FIG. 2 is a plan view schematically showing a circuit configuration of a TFT substrate 10 of the liquid crystal display device 101 in Embodiment 1.

FIG. 3 is a plan view schematically showing a structure of one pixel of the liquid crystal display device 101.

FIGS. 4(a) and (b) are respectively cross-sectional views showing structures of an cross-section and a B-B′ cross-section of the liquid crystal display device 101 in FIG. 3.

FIG. 5 provides views for explaining alignment of liquid crystal molecules 51 in a liquid crystal layer 50; FIGS. 5(a) and (b) illustrate alignment in the absence of a voltage on the liquid crystal layer 50; and FIGS. 5(c) and (d) illustrate alignment in the presence of a voltage on the liquid crystal layer 50.

FIGS. 6(a) through (h) are cross-sectional views showing a method for producing a TFT substrate 30 of the liquid crystal display device 101.

FIGS. 7(a) and (b) are cross-sectional views showing a method for producing a counter substrate 40 of the liquid crystal display device 101.

FIG. 8 is a plan view schematically showing a structure of one pixel of a liquid crystal display device 102 in Embodiment 2.

FIGS. 9(a) and (b) are respectively cross-sectional views showing structures of an cross-section and a B-B′ cross-section of the liquid crystal display device 102 in FIG. 8.

FIG. 10 provides views for explaining alignment of liquid crystal molecules 51 in a liquid crystal layer 50; FIGS. 10(a) and (b) illustrate alignment in the absence of a voltage on a liquid crystal layer 50; and FIGS. 10(c) and (d) illustrate alignment in the presence of a voltage on the liquid crystal layer 50.

FIGS. 11(a) through (c) are cross-sectional views showing a second half of a method for producing a TFT substrate 30 of the liquid crystal display device 102.

FIG. 12 is a plan view schematically showing a structure of one pixel of a liquid crystal display device 100 as an example of reflective-transmissive liquid crystal display device.

FIGS. 13(a) and (b) are respectively cross-sectional views showing structures of an A-A′ cross-section and a B-B′ cross-section of the liquid crystal display device 100 in FIG. 12.

FIG. 14(a) through (e) are cross-sectional views showing a first half of a method for producing a TFT substrate 30 of the liquid crystal display device 100.

FIG. 15(f) through (i) are cross-sectional views showing a second half of the method for producing the TFT substrate 30 of the liquid crystal display device 100.

FIGS. 16(a) and (b) are cross-sectional views showing a method for producing a counter substrate 40 of the liquid crystal display device 100.

### DESCRIPTION OF EMBODIMENTS

Hereinafter, a structure of a reflective-transmissive liquid crystal display device according to the present invention will be described with reference to the drawings, but the present invention is not limited to the following embodiments. In the following description, elements corresponding to those of the liquid crystal display device 100 described above bear the same reference signs.

### Embodiment 1

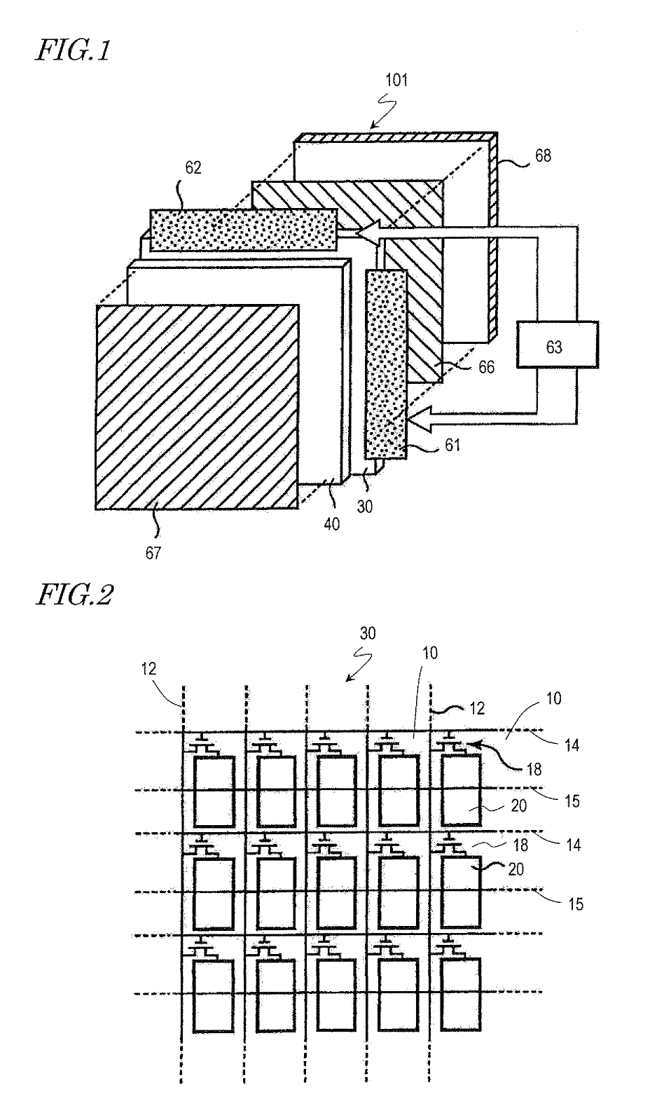

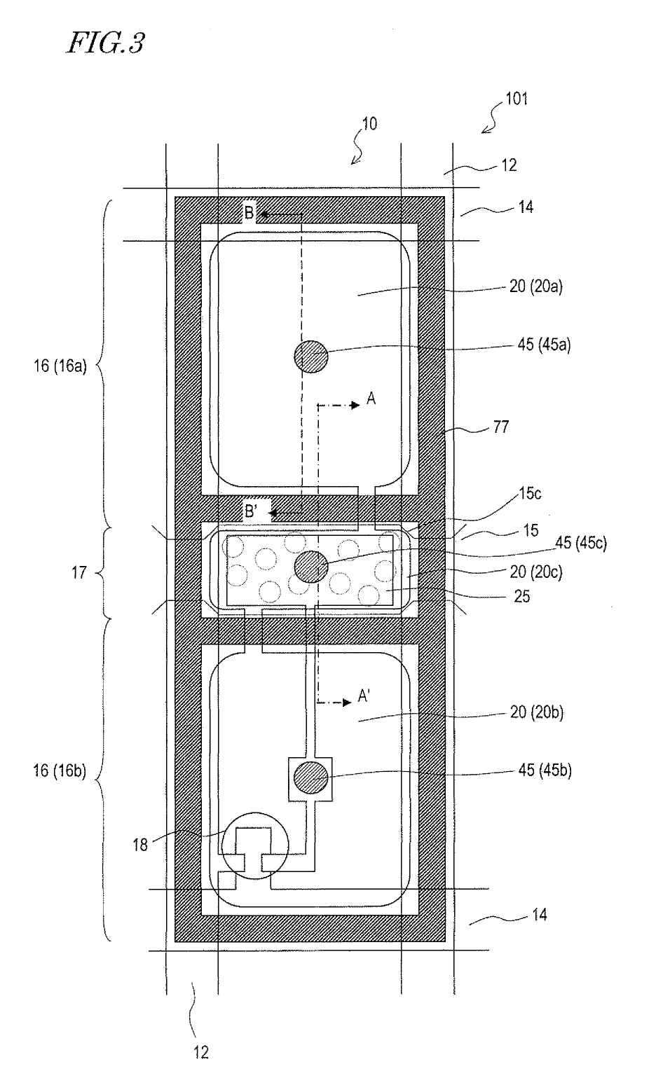

FIG. 1 schematically shows a structure of a liquid crystal display device 101 in Embodiment 1 according to the present invention. FIG. 2 schematically shows a circuit configuration of a TFT substrate 30 of the liquid crystal display device 100.

As shown in FIG. 1, the liquid crystal display device 101 includes the TFT substrate 30 and a counter substrate 40 facing each other with a liquid crystal layer interposed therebetween, polarizer plates 66 and 67 respectively bonded to outer surfaces of the TFT substrate 30 and the counter substrate 40, and a backlight unit 68 for emitting light for display.

As shown in FIG. 2, the TFT substrate 30 includes a plurality of scanning lines (gate bus lines) 14 and a plurality of signal lines (data bus lines) 12 located so as to cross each other perpendicularly. In the vicinity of each of intersections of the scanning lines 14 and the signal lines 12, a TFT 18 is formed for each of pixels 10. Herein, the pixels 10 are defined as areas separated from one another by the center lines of two adjacent scanning lines 14 and the center lines of two adjacent signal lines 12. In each pixel 10, a pixel electrode 20 formed of ITO and electrically connected to a source electrode of the TFT 18 is located. Between two adjacent scanning lines 14, a storage capacitance line 15 extends parallel to the scanning lines 14.

As shown in FIG. 1, the scanning lines 14 are connected to a scanning line driving circuit 61, and the signal lines 12 are connected to a signal line driving circuit 62. The scanning lines 14 are supplied with a scanning signal for switching the TFT 18 on or off from the scanning line driving circuit 61 in accordance with control by a control circuit 63. The signal lines 12 are supplied with a display signal (voltage applied to the pixel electrode 20) from the signal line driving circuit 62 in accordance with control by the control circuit 63.

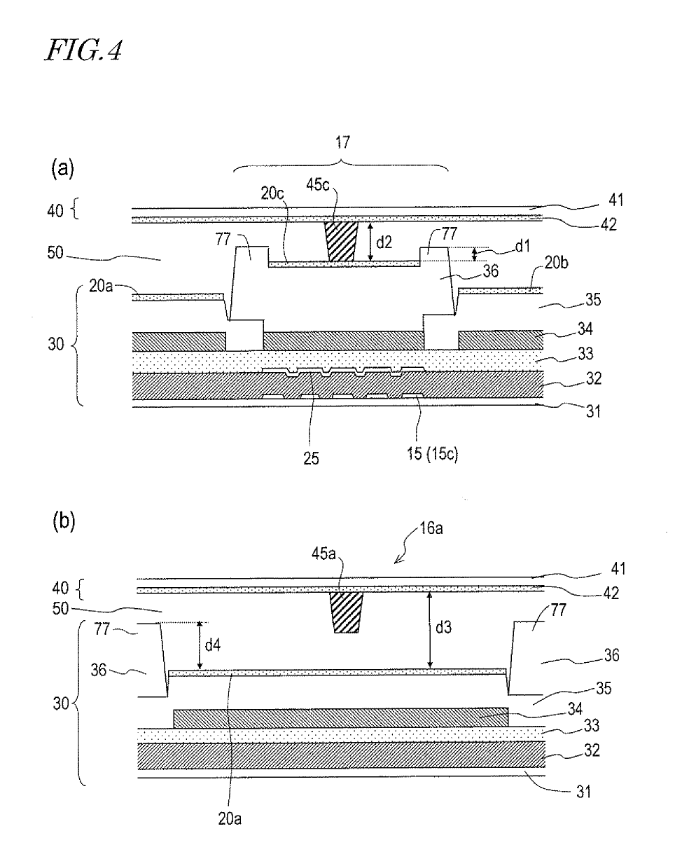

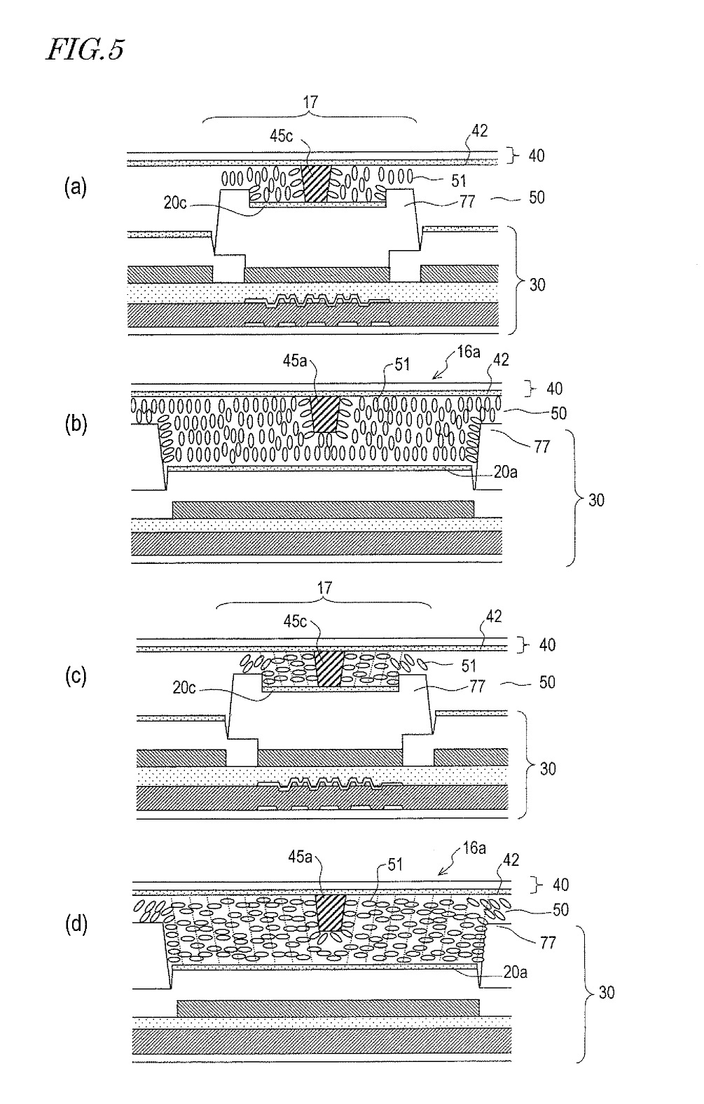

FIG. 3 is a plan view schematically showing a structure of one pixel of the liquid crystal display device 101. FIGS. 4(a) and (b) are respectively cross-sectional views showing structures of an A-A′ cross-section and a B-B′ cross-section of the liquid crystal display device 101 in FIG. 3.

The pixel 10 in the liquid crystal display device 101 includes two transmissive regions 16 (an upper transmissive region is represented by 16a and a lower transmissive region is represented by 16b) and one reflective region 17 interposed between the two transmissive regions 16a and 16b. The pixel electrode 20 of the pixel 10 includes a sub pixel electrode 20a (corresponding to the second sub pixel electrode) in the transmissive region 16a, a sub pixel electrode 20b (corresponding to the second sub pixel electrode) in the transmissive region 16b, and a sub pixel electrode 20c (corresponding to the first sub pixel electrode) in the reflective region 17. The sub pixel electrode 20a and the sub pixel electrode 20c are connected to each other with a part of the pixel electrode 20, and the sub pixel electrode 20b and the sub pixel electrode 20c are connected to each other with a part of the pixel electrode 20.

In the vicinity of an intersection of the signal line 12 and the scanning line 14 in a lower left part of the pixel 10, the TFT 18 is located. A gate electrode of the TFT 18 is connected to the scanning line 14, a drain electrode of the TFT 18 is connected to the signal line 12, and the source electrode of the TFT 18 is connected to the sub pixel electrode 20b. Below the reflective region 17 of the pixel electrode 10, the storage capacitance line (Cs line) 15 extends in the left-right direction. Between the storage capacitance line 15 and the sub pixel electrode 20c, a reflective layer 25 is formed. The reflective layer 25 is electrically connected to the source electrode of the TFT 18 and acts as an intermediate electrode. A part of the storage capacitance line 15 which is below the reflective layer (intermediate electrode) 25 acts as a storage capacitance electrode 15c, so that a storage capacitance of the pixel 10 is formed between the reflective layer 25 and the storage capacitance electrode 15c.

FIG. 4(a) is a cross-sectional view of the reflective region 17, and FIG. 4(b) is a cross-sectional view of the transmissive region 16a. As shown in FIG. 4, the liquid crystal display device 101 includes the TFT substrate 30, the counter substrate 40, and a liquid crystal layer 50 located between the TFT substrate 30 and the counter substrate 40. The liquid crystal layer 50 is a vertical alignment type liquid crystal layer containing liquid crystal molecules having a negative dielectric anisotropy.

The TFT substrate 30 includes a glass substrate 31, a gate insulating layer 32 formed on the glass substrate 31, a protective layer 33 formed on the gate insulating layer 32, a color filter (CF) 34 (corresponding to the color filter layer) formed on the protective layer 33, and a transparent insulating layer (JAS) layer 35 (corresponding to the first transparent layer) formed on the color filter 34. In the reflective region 17, a transparent resin layer 36 (corresponding to the second transparent layer) is formed on the color filter 34, and the sub pixel electrode 20c is formed on the transparent resin layer 36. The transparent resin layer 36 is not formed below any of the sub pixel electrodes 20a and 20b in the transmissive region 16a and 16b, and the sub pixel electrodes 20a and 20b are formed on the transparent insulating layer 35.

The transparent insulating layer 35 and the transparent resin layer 36 are also formed between the sub pixel electrodes 20a and 20c, in an area between the sub pixel electrodes 20c and 20b, and between the pixels 20 of two adjacent pixels 10; namely, at a border between the transmissive region 16a and the reflective region 17, at a border between the reflective region 17 and the transmissive region 16b, and at a border between two adjacent pixels 10. At these borders, the transparent insulating layer 35 and the transparent resin layer 36 are stacked, and therefore the transparent resin layer 36 includes an elevated portion (rib) (corresponding to the first elevated portion) protruding toward the liquid crystal layer 50 more than the sub pixel electrode 20c by distance d1. The value of d1 is, for example, 0.5 μm or greater and 1.0 μm or less. As shown in FIG. 3, the elevated portion 77 extends around the transmissive regions 16a and 16b and the reflective region 17 so as to surround each of the sub pixel electrodes 20a, 20b and 20c. Below the elevated portion 77, the color filter 34 has an opening or a hollow.

In the reflective region 17, the storage capacitance electrode 15c is formed between the glass substrate 31 and the gate insulating layer 32, and the reflective layer 25 is formed between the gate insulating layer 32 and the protective layer 33. The reflective layer 25 has ruggedness for diffusively reflecting light. The ruggedness reflects the opening or the hollow formed in the storage capacitance electrode 15c below the reflective layer 25.

Between the gate insulating layer 32 and the protective layer 33, the TFT 18 shown in FIG. 3 is also formed. The TFT 18 includes an operative semiconductor layer included in a channel of the TFT 18 and formed of, for example, amorphous silicon (a-Si) and an ohmic contact layer formed of n⁺-Si. The ohmic contact layer is connected to the source electrode and the drain electrode, and the source electrode is electrically connected to the sub pixel electrode 20b located thereabove via a contact hole formed through the protective layer 33, the color filter 34 and the transparent insulating layer 35. The source electrode is also electrically connected to the reflective layer 25 in the reflective region 17. The reflective layer 25 is electrically connected to the sub pixel electrode 20c located thereabove via a contact hole formed through the protective layer 33, the color filter 34, and the transparent resin layer 36.

The counter substrate 40 includes a glass substrate 41, a counter electrode 42 formed on the glass substrate 41 on the liquid crystal layer 50 side, and elevated portions (ribs) (45a, 45b and 45c) formed at three positions on a surface of the counter electrode 42, the surface facing the liquid crystal layer 50. The elevated portions 45a (corresponding to the third elevated portion), 45b (corresponding to the third elevated portion) and 45c (corresponding to the second elevated portion) are formed above the central positions of the sub pixel electrodes 20a, 20b and 20c, respectively.

Cell gap d2 in the reflective region 17 (the distance between the sub pixel electrode 20c and the counter electrode 42, or the thickness of the liquid crystal layer 50 between these electrodes) is, for example, 1.7 μm. Cell gap d3 in the transmissive regions 16a and 16b (the distance between the sub pixel electrode 20a/20b and the counter electrode 42, or the thickness of the liquid crystal layer 50 between these electrodes) is, for example, 3.4 μm. As can be seen, the cell gap of the transmissive regions 16a and 16b is twice the cell gap of the reflective region 17. It is preferable that the cell gap of the transmissive regions 16a and 16b is 1.7 times or greater and 2.3 times or less of the cell gap of the reflective region 17. Distance d4 from a surface of the sub pixel electrodes 20a and 20b, the surface facing the liquid crystal layer 50, to a top surface of the elevated portion 77 (distance in the direction vertical to the surfaces of the substrates) is 2.2 μm or greater and 2.7 μm or less.

The elevated portions 45a, 45b and 45c, together with the elevated portion 77 in the TFT substrate 30, act as alignment control means for aligning the liquid crystal molecules in the transmissive region 16a, the transmissive region 16b and the reflective region 17 radially around the elevated portions 45a, 45b and 45c as the center. The elevated portion 45c extends from the counter electrode 42 so as to contact the sub pixel electrode 20c and thus also acts as a spacer for keeping the cell gap at a certain level.

FIG. 5 provides views for explaining alignment of liquid crystal molecules 51 in the liquid crystal layer 50. FIGS. 5(a) and (b) respectively illustrate alignment of the liquid crystal molecules 51 in the reflective region 17 and the transmissive region 16a in the absence of a voltage between the pixel electrode 20 and the counter electrode 42. FIGS. 5(c) and (d) respectively illustrate alignment of the liquid crystal molecules 51 in the reflective region 17 and the transmissive region 16a in the presence of a voltage between the pixel electrode 20 and the counter electrode 42.

As shown in FIGS. 5(a) and (b), in the absence of a voltage, almost all the liquid crystal molecules are aligned approximately vertical to the surfaces of the substrates by an action of alignment films (not shown) formed on the surfaces of the pixel electrode 20 and the counter electrode 42, the surfaces facing the liquid crystal layer 50. It should be noted, though, that the alignment films are also formed on surfaces of the elevated portions 77 and 45, the surfaces being in contact with the liquid crystal layer 50, and so the liquid crystal molecules 51 in the vicinity of the elevated portions 77 and 45 tend to be aligned vertical to these surfaces. Therefore, the liquid crystal molecules 51 in the vicinity of the elevated portions 77 and 45 are aligned to be inclined with respect to the surfaces of the substrates, and to be directed inward in each of the reflective region 17 and the transmissive regions 16a and 16b. Such an inclined alignment of the liquid crystal molecules 51 in the absence of a voltage will be referred to as the “pretilt”.

As shown in FIGS. 5(c) and (d), when the TFT 18 is turned on and a voltage is applied between the electrodes by the signal line 12, the liquid crystal molecules 51 are aligned to be inclined in a direction closer to a parallel direction to an equipotential surface, namely, in a direction closer to a parallel direction to the surfaces of the substrates. At this point, the liquid crystal molecules 51 are pulled by the orientation of the liquid crystal molecules 51 pretilted in the absence of a voltage and thus are aligned in each of the reflective region 17, the transmissive region 16a and the transmissive region 16b radially, approximately toward the center of the respective area (approximately toward the center of each of the elevated portions 45a, 45b and 45c) or from the center toward the outside of the respective area.

In this manner, the liquid crystal molecules 51 can be aligned more isotropically in a plane parallel to the surfaces of the substrates in each of the reflective region 17, the transmissive region 16a and the transmissive region 16b. Therefore, the viewing angle characteristics of display are improved. In addition, the orientation of the liquid crystal molecules 51 in the presence of a voltage is defined by the pretilt in the presence of a voltage. Therefore, the response speed of display is improved.

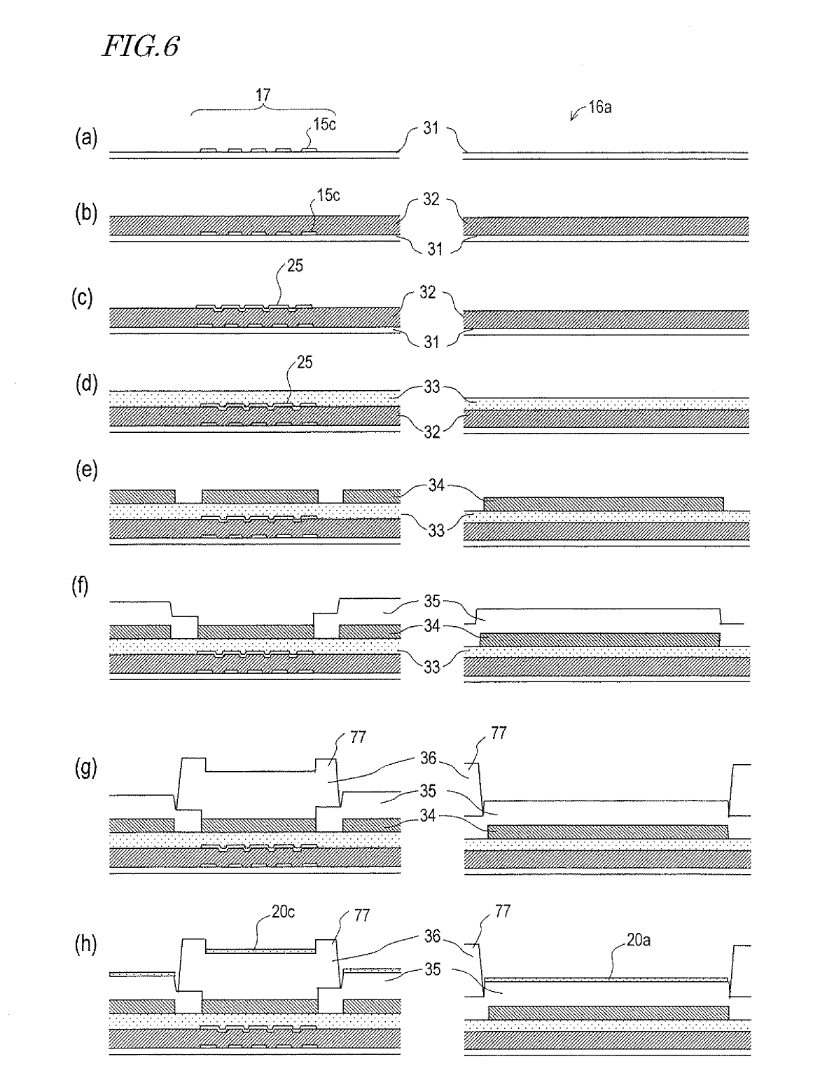

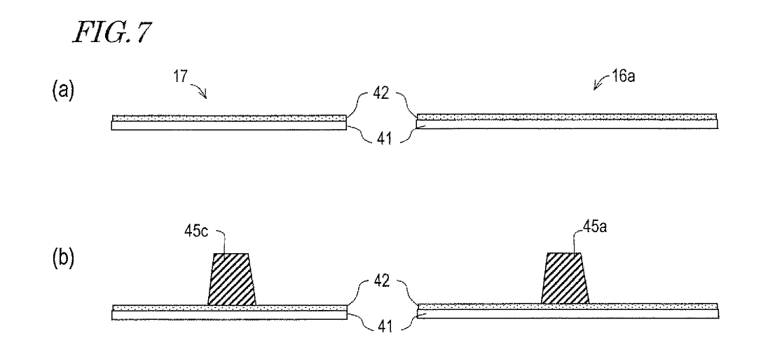

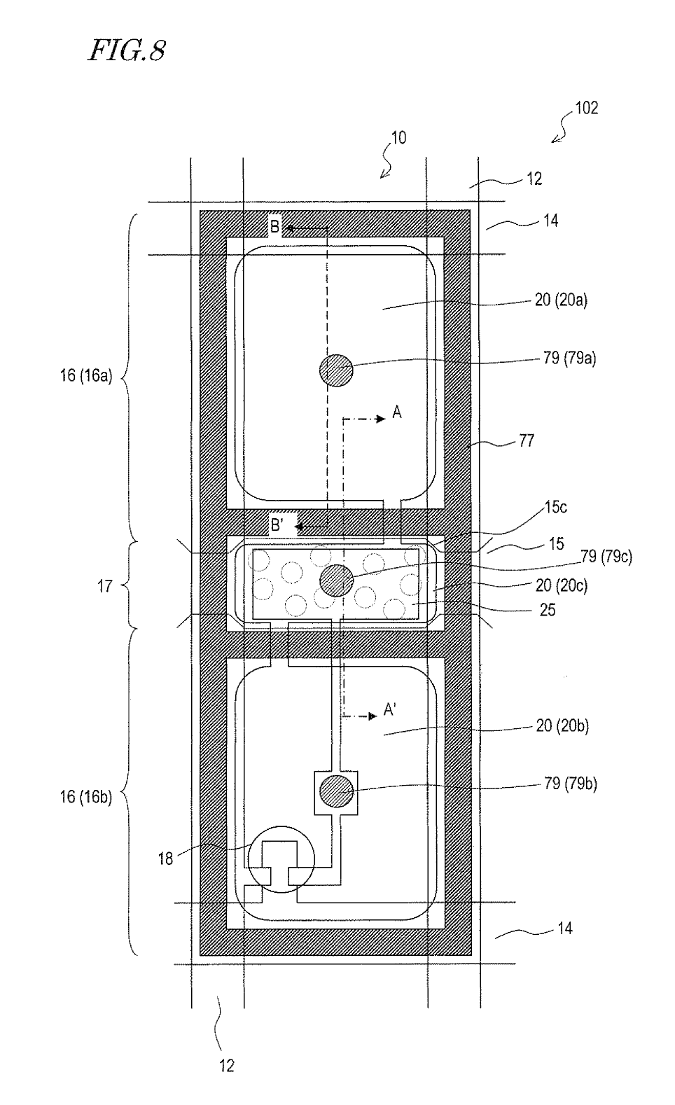

Now, with respect to FIG. 6 and FIG. 7, a method for producing the liquid crystal display device 101 will be described. FIGS. 6(a) through (h) are cross-sectional views showing a method for producing the TFT substrate 30 of the liquid crystal display device 101. FIGS. 7(a) and (b) are cross-sectional views showing a method for producing the counter substrate 40 of the liquid crystal display device 101. In each figure, the cross-sectional view of the reflective region 17 (corresponding to the A-A′ cross-section in FIG. 3) is shown on the left, and the cross-sectional view of the transmissive region 16a (corresponding to the B-B′ cross-section in FIG. 3) is shown on the right.

For producing the TFT substrate 30, first, on the entirety of a top surface of the glass substrate 31, which is a transparent insulating substrate, Al (aluminum) or an Al alloy is applied in a layer to a thickness of, for example, 130 nm by sputtering. When necessary, before the application, a protective layer of SiOₓ or the like may be formed on the top surface of the glass substrate 31. Next, on the applied Al or the like, Ti (titanium) or a titanium alloy is applied in a layer to a thickness of, for example, 70 nm by sputtering. Thus, a metal layer having a thickness of about 200 nm is formed. Instead of Ti, Cr (chromium), Mo (molybdenum), Ta (tantalum), W (tungsten) or an alloy thereof may be used. Instead of Al, a material containing one or a plurality of Nd (neodymium), Si (silicon), Cu (copper), Ti, W, Ta and Sc may be used.

Then, a resist layer is formed on the metal layer and subjected to exposure using a first mask (photomask or reticle; hereinafter, referred to simply as the “mask”) to form a resist mask, and the metal layer is patterned by dry etching with a chlorine-based gas. Thus, as shown in FIG. 6(a), the storage capacitance electrode 15c is formed. At the same time, the scanning lines 14, the storage capacitance line 15, and the gate electrode of the TFT 18 are also formed. In this step, an opening or a hollow is formed in the storage capacitance electrode 15c.

Next, as shown in FIG. 6(b), a silicon nitride film (SiN), for example, is formed on the entire surface of the substrate to a thickness of about 400 nm by plasma CVD to obtain the gate insulating layer 32. Next, in order to form the operative semiconductor layer of the TFT 18, an amorphous silicon (a-Si) layer (not shown), for example, is stacked on the entire surface of the substrate to a thickness of about 30 nm by plasma CVD. In order to form a channel protective film (etching stopper) of the TFT 18, a silicon nitride film (SiN) (not shown), for example, is formed on the entire surface of the substrate to a thickness of about 150 nm by plasma CVD.

Next, a photoresist is applied on the entire surface of the substrate by spin-coating or the like, and then subjected to rear exposure from the glass substrate 31 side using the scanning lines 14, the storage capacitance line 15 and the storage capacitance electrode 15c as a mask. Then, the exposed resist layer is dissolved to form a resist pattern on the scanning lines 14, the storage capacitance line 15 and the storage capacitance electrode 15c in a self-aligned manner.

The resist pattern is further subjected to exposure using a second mask in a forward direction (from the side opposite to the glass substrate 31) to leave the resist layer only on an area in which the channel protective film is to be formed. Then, the silicon nitride film is dry-etched with a fluorine-based gas using the resist layer as a mask to form the channel protective film. As shown in FIG. 6(b), the channel protective film is not provided above the storage capacitance electrode 15c.

Next, the surface of the amorphous silicon layer is washed using diluted hydrogen fluoride to remove the oxide film. Then, in order to form the ohmic contact layer of the TFT 18, n⁺a-Si, for example, is applied in a layer promptly on the entire surface of the substrate to a thickness of about 30 nm by plasma CVD. Next, an Al layer (or an Al alloy layer), for example, and a high melting point metal layer of Ti or a Ti alloy are stacked to respective thicknesses of 100 nm and 80 nm by sputtering to obtain a conductive layer. The conductive layer is used to form the reflective layer 25 acting as one of a pair of electrodes (acting as the intermediate electrode) for forming a storage capacitance (accumulation capacitance) and also used to form the drain electrode and the source electrode of the TFT 18. For the high melting point metal layer, Cr, Mo, Ta, W or an alloy thereof may also be used.

Next, a photoresist layer is formed on the entire surface of the substrate, and the resist is subjected to exposure using a third mask. Then, the resist layer is patterned by development. Using the patterned resist layer as an etching mask, dry etching is performed on the conductive layer, the n⁺a-Si layer and the amorphous silicon layer with a chlorine-based gas. Thus, the reflective layer 25 as shown in FIG. 6(c) is obtained, and at the same time, the signal lines 12, and the drain electrode, the source electrode, the ohmic layer and the operative semiconductor layer of the TFT 18 are also formed. During the etching treatment, the channel protective film acts as an etching stopper. Therefore, the amorphous silicon layer in the channel region is left without being etched away, and so a desired operative semiconductor layer is formed.

Next, as shown in FIG. 6(d), a silicon nitride film (SiN), for example, is formed on the entire surface of the substrate to a thickness of about 300 nm by plasma CVD to form the protective layer 33.

Next, as shown in FIG. 6(e), the color filters 34 of R (red), G (green) and B (blue) resins are formed for R, G and B pixels by photolithography. In this step, among the plurality of pixels arranged in a matrix, the pixels of the same column (each of columns of pixels arranged in the up-down direction in FIG. 2) are provided with the color filters 34 of the same color.

In this step, first, for example, an acrylic negative photosensitive resin containing a red (R) pigment (red resin) is applied on the entire surface of the substrate to a thickness of, for example, 170 nm by a spin-coater, a slit-coater or the like. Next, proximity exposure is performed using a fourth mask so that the resin is left in stripes corresponding to a prescribed plurality of columns of pixels. Next, development is performed using an alkaline developer of KOH (potassium hydroxide) or the like to form the color filters 34 of the red resin. Thus, the red pixels are each provided with red spectroscopic characteristics and also a light-blocking function of preventing external light from being incident on the TFT 18.

In a similar manner, an acrylic negative photosensitive resin having a blue (B) pigment dispersed therein (blue resin) is applied and is patterned using a fifth mask to form the color filters 34 of the blue resin for columns of pixels different from the red pixels. Thus, the blue pixels are each provided with blue spectroscopic characteristics and also a light-blocking function of preventing external light from being incident on the TFT 18.

Furthermore, an acrylic negative photosensitive resin having a green (G) pigment dispersed therein (green resin) is applied and is patterned using a sixth mask to form the color filters 34 of the green resin for columns of pixels between the columns of red pixels and the columns of blue pixels. Thus, the green pixels are each provided with green spectroscopic characteristics and also a light-blocking function of preventing external light from being incident on the TFT 18.

In the step of forming the color filters 34, a contact hole for electrically connecting the drain electrode of the TFT 18 to the layer thereabove is formed in each color filter 34.

Next, a transparent insulating resin is applied on the entire surface of the substrate by a spin-coater, a slit-coater or the like, and is heated at a temperature of 140° C. or lower. The transparent insulating resin used in this step is an acrylic resin having a negative photosensitivity. Next, the transparent insulating resin is subjected to proximity exposure using a seventh mask and developed using an alkaline developer of KOH or the like to form the transparent insulating layer 35 as shown in FIG. 6(f).

The transparent insulating layer 35 is formed on the color filter 34 in the transmissive regions 16 and on areas between the transmissive regions 16 and the reflective region where the color filter 34 is not formed (the hollow of the color filter 34 may be formed), but is not formed on the color filter 34 in the reflective region 17.

In this step, a contact hole for electrically connecting the drain electrode of the TFT 18 to the layer thereabove is formed in the transparent insulating layer 35, above the contact hole formed in the color filter 34. In the contact hole, the protective layer 33 is exposed. Contact holes are also formed in at least an area where terminals are to be formed and an area where electrodes are to be connected. In these contact holes, the gate insulating layer 32 or the protective layer 33 is exposed. Next, dry etching is performed with a fluorine-based gas using the transparent insulating layer 35 as a mask to remove a part of the protective layer 33 and a part of the gate insulating layer 32 which are below the contact holes.

Next, a transparent acrylic resin is applied on the entire surface of the substrate by a spin-coater, a slit-coater or the like, and is heated at a temperature of 140° C. or lower. The transparent acrylic resin used in this step is an acrylic resin having a negative photosensitivity. The transparent acrylic resin is subjected to proximity exposure using an eighth mask and developed using an alkaline developer of KOH or the like to form the transparent resin layer 36 as shown in FIG. 6(g).

The transparent resin layer 36 is formed in the reflective region 17 or above the storage capacitance line 15 shown in FIG. 3, and extends in stripes in the left-right direction. The transparent resin layer 36 is formed on the color filter 34 in the reflective region 17 and on areas between the transmissive regions 16 and the reflective region where the color filter 34 is not formed, but is not formed on the color filter 34 in any of the transmissive regions 16a and 16b. In the step of forming the transparent resin layer 36, the projection 77 of the transparent resin layer 36 is formed by forming the transparent resin layer 36 on the transparent insulating layer 35.

Next, ITO (indium thin oxide), which is a transparent oxide conductive material, is applied in a layer on the entire surface of the substrate to a thickness of 70 nm by a thin film formation technique such as sputtering or the like. Then, a resist mask having a prescribed pattern is formed using a ninth mask, and ITO is wet-etched with an oxalic acid-based etchant to obtain the pixel electrode 20 as shown in FIG. 6(h). After the pixel electrode 20 is formed, the substrate is heated at a temperature in the range of 150 to 230° C., preferably at a temperature of 200° C.

The sub pixel electrodes 20a, 20b and 20c included in the pixel electrode 20 are electrically connected to each other with a part of the pixel electrode 20. The sub pixel electrode 20b is electrically connected to the source electrode of the TFT 18 and the reflective layer (intermediate electrode) 25 via the contact holes. The pixel electrode 20 is not formed on the elevated portion 77. The elevated portion 77 is formed at the border between adjacent pixels 10 (an area between two adjacent pixel electrodes 20) and at the borders between the transmissive regions 16 and the reflective region 17, so as to surround each of the sub pixel electrodes 20a, 20b and 20c.

Now, with reference to FIG. 7, a method for producing the counter substrate 40 will be described.

First, on the entirety of a surface of the glass substrate 41, which is a transparent insulating substrate, ITO, which is a transparent oxide conductive material, for example, is applied in a layer to a thickness of 100 nm by sputtering or the like. Thus, as shown in FIG. 7(a), the counter electrode 42 of ITO is formed.

Next, a transparent acrylic resin is applied on the entirety of a top surface of the counter electrode 42 by a spin-coater, a slit-coater or the like, and is heated at a temperature of 140° C. or lower. The transparent acrylic resin used in this step is an acrylic resin having a negative photosensitivity. Next, the transparent acrylic resin is subjected to proximity exposure using a 10th mask and developed using an alkaline developer of KOH or the like to form the elevated portions (ribs) 45a and 45c shown in FIG. 7(b). At the same time, the elevated portion 45b shown in FIG. 3 is also formed. The elevated portions 45a, 45b and 45c are respectively located approximately at the centers of the sub pixel electrodes 20a, 20b and 20c.

The liquid crystal display device 101 formed in this manner can stably align the liquid crystal molecules radially in each of the transmissive region 16a, the transmissive region 16b and the reflective region 17 by means of the elevated portions 77, 45a, 45b and 45c, and so can provide display with a high response speed and superb viewing angle characteristics. In addition, owing to ruggedness reflecting the shape of the storage capacitance electrode 15c which is formed in the reflective layer 25 in the reflection area 17, the liquid crystal display device 101 can reflect the reflected light diffusely and so can provide high viewing angle characteristics.

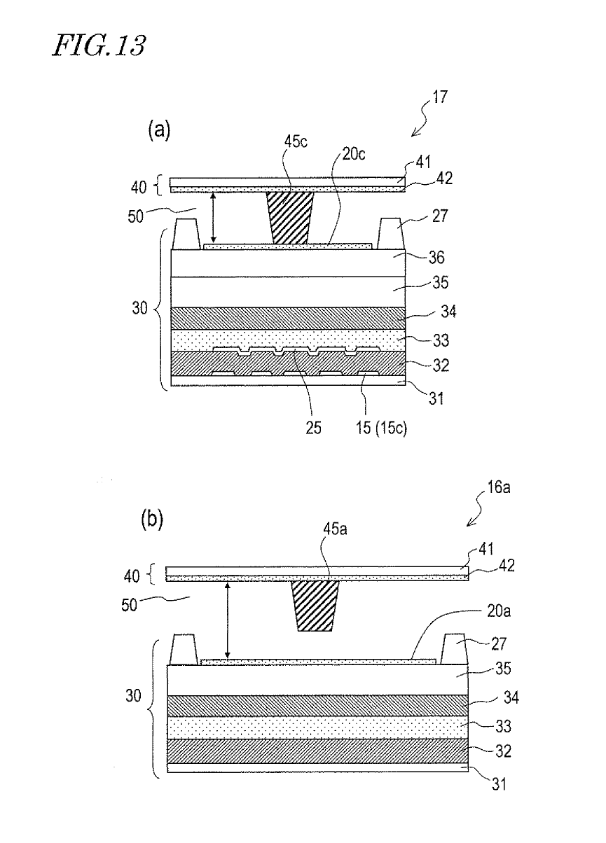

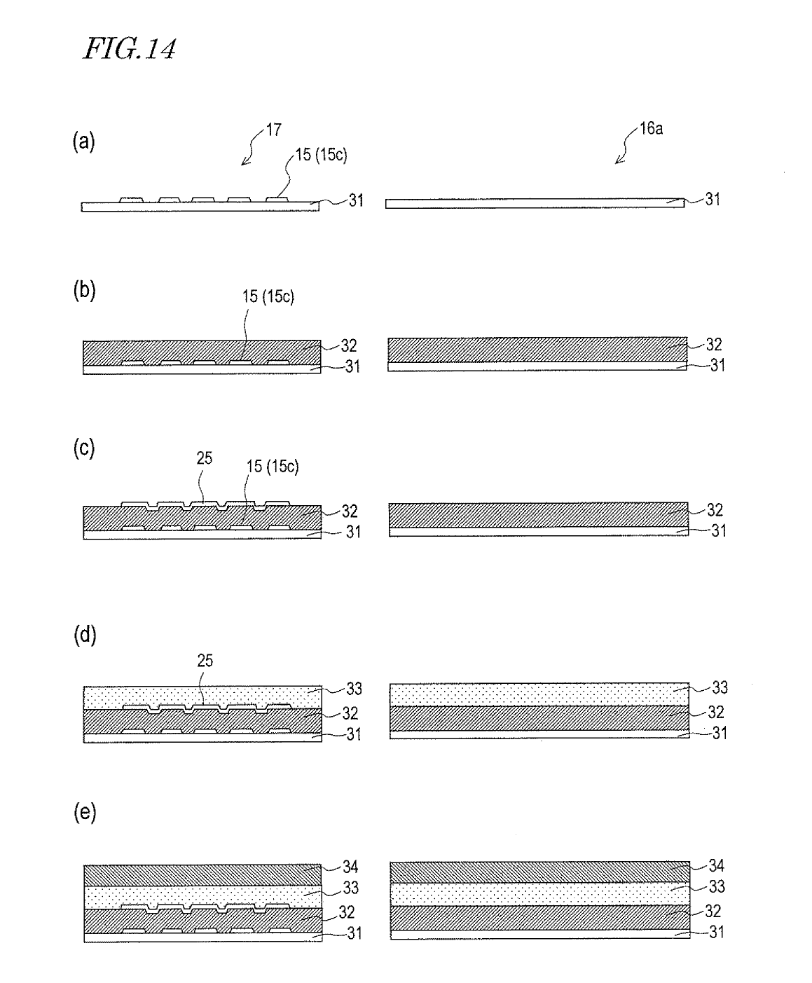

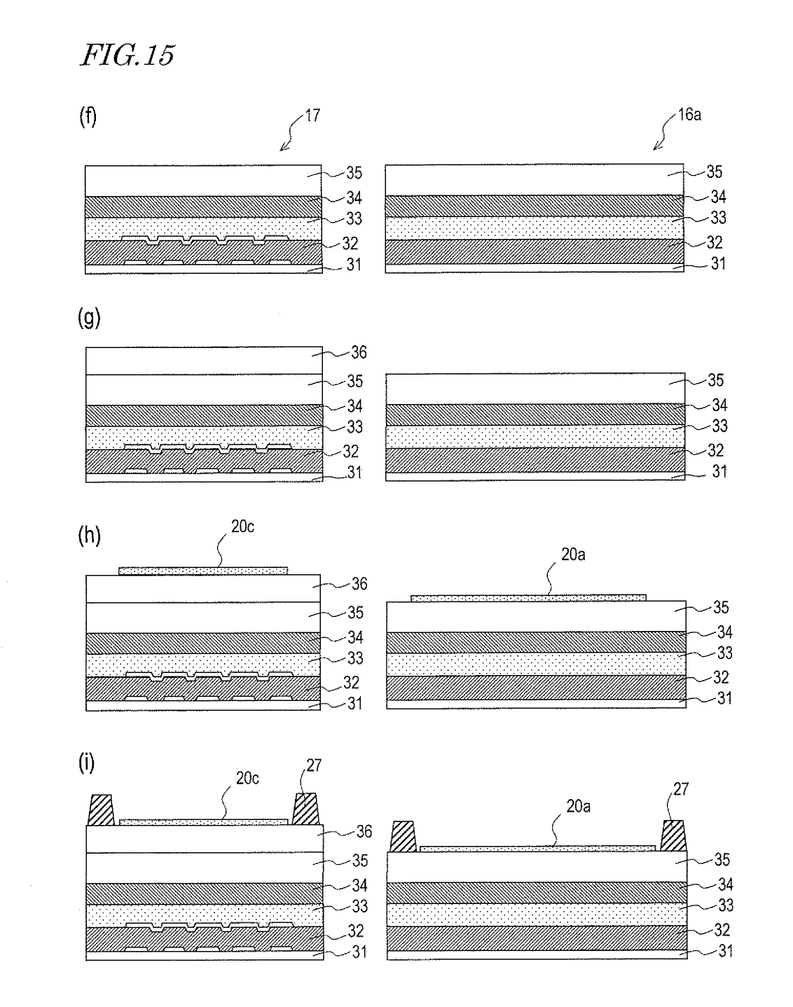

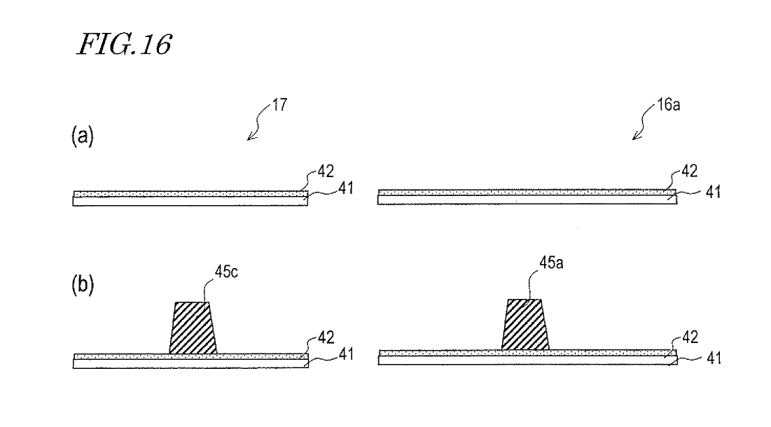

The production of the liquid crystal display device 101 requires masks of merely a number smaller by one than in the case of the liquid crystal display device 100 shown in FIG. 12 (10 masks in this embodiment), and so can be more efficient or simpler.

### Embodiment 2

Now, a liquid crystal display device 102 in Embodiment 2 according to the present invention will be described. The basic structure of the liquid crystal display device 102 is the same as that in Embodiment 1 shown in FIG. 1 and FIG. 2, and will not be described.

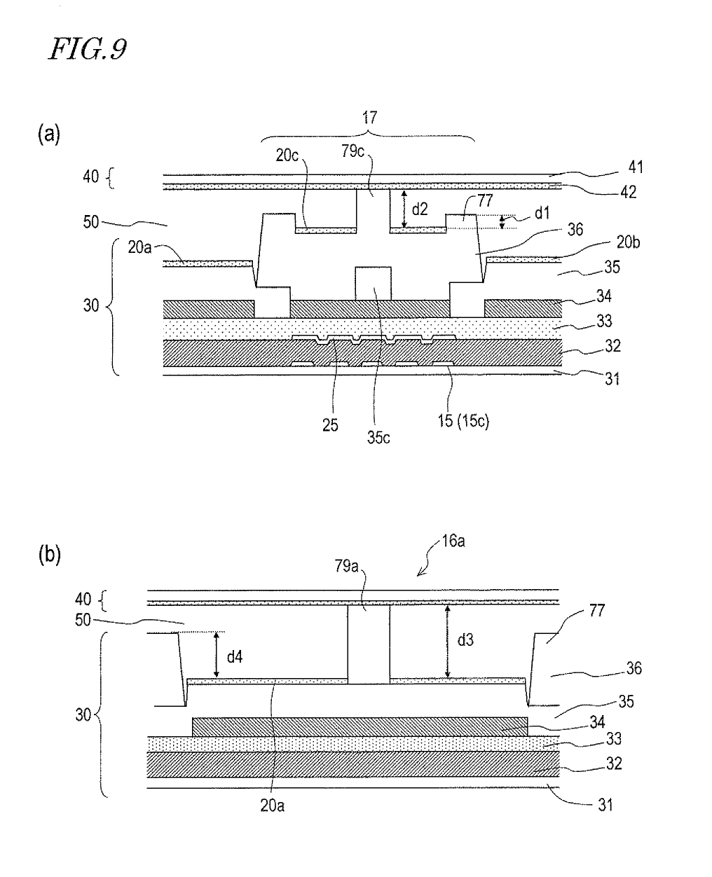

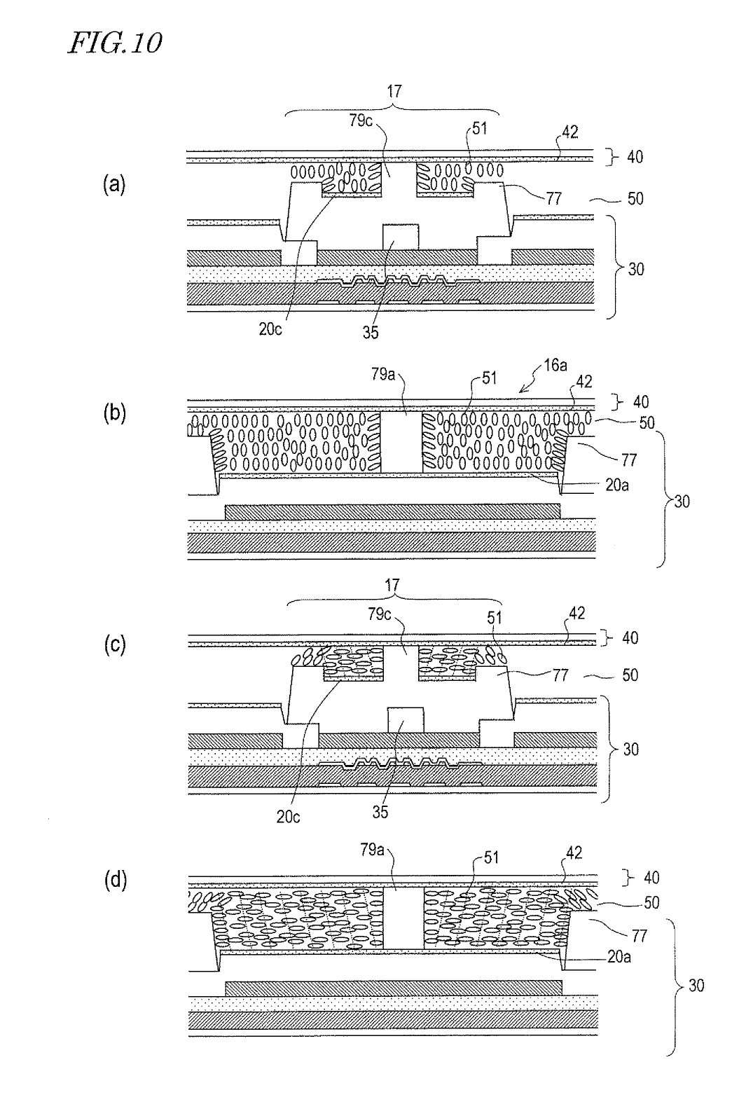

FIG. 8 is a plan view schematically showing a structure of one pixel of the liquid crystal display device 102. FIGS. 9(a) and (b) are respectively cross-sectional views showing the structures of an A-A′ cross-section and a B-B′ cross-section of the liquid crystal display device 102 in FIG. 8.

The pixel 10 of the liquid crystal display device 102 basically has the same structure as that of the liquid crystal display device 101 shown in FIG. 3. However, the liquid crystal display device 102 does not include the elevated portion 77 formed in the counter substrate 40 of the liquid crystal display device 101, and instead, includes an elevated portion 79 formed in the TFT substrate 30. Hence, hereinafter, a structure of the elevated portion 79 and elements relating to the elevated portion 79 will be mainly described, and descriptions on the same elements as those in the liquid crystal display device 101 will be mostly omitted.

As shown in FIG. 8 and FIG. 9, the elevated portion 79 includes elevated portions 79a (corresponding to the fifth elevated portion and the second central elevated portion), 79b (corresponding to the fifth elevated portion and the second central elevated portion), and 79c (corresponding to the fourth elevated portion and the first central elevated portion) respectively formed in central portions of the two transmissive regions 16a and 16b and the reflective region 17. The elevated portions 79a, 79b and 79c are formed as a part of the transparent resin layer 36 so as to reach the counter electrode 42.

The TFT substrate 30 includes the transparent insulating layer 35 formed on the protective layer 33 and the color filter 34. In the reflective region 17, the transparent insulating layer 35 is formed in a portion where the color filter 34 is not formed and also in the central portion of the reflective region 17 (on a part of the color filter 34 which is below the elevated portion 79c). A part of the transparent insulating layer 35 which is formed in the central portion of the reflective region 17 will be referred to as the “transparent insulating layer 35c”.

In the reflective region 17, the transparent resin layer 36 is formed on the color filter 34 (also on the transparent insulating layer 35c) and the sub pixel electrode 20c is formed on the transparent resin layer 36. The transparent resin layer 36 is not formed below any of the sub pixel electrodes 20a and 20b in the transmissive regions 16a and 16b, and the sub pixel electrodes 20a and 20b are formed on the transparent insulating layer 35. The transparent resin layer 36 is also formed in the central portions of the transmissive regions 16a and 16b to form the elevated portions 79a and 79b, respectively. In the central portion of each of the sub pixel electrodes 20a and 20b, an opening is formed, and the elevated portions 79a and 79b are formed so as to fill such openings, namely, on parts of the transparent insulating layer 35 which are in the central portions of the transmissive regions 16a and 16b.

The transparent insulating layer 35 and the transparent resin layer 36 are also formed between the sub pixel electrodes 20a and 20c, in an area between the sub pixel electrodes 200 and 20b, and between the pixels 20 of two adjacent pixels 10; namely, at a border between the transmissive region 16a and the reflective region 17, at a border between the reflective region 17 and the transmissive region 16b, and at a border between two adjacent pixels 10. At these borders, the transparent insulating layer 35 and the transparent resin layer 36 are stacked, and therefore the transparent resin layer 36 includes an elevated portion (rib) 77 protruding toward the liquid crystal layer 50 more than the sub pixel electrode 20c by distance d1. The value of d1 is, for example, 0.5 μm or greater and 1.0 μm or less. As shown in FIG. 8, the elevated portion 77 extends around the transmissive regions 16a and 16b and the reflective region 17 so as to surround each of the sub pixel electrodes 20a, 20b and 20c.

The counter substrate 40 includes the glass substrate 41 and the counter electrode 42 formed on the glass substrate 41 on the liquid crystal layer 50 side. On a surface of the counter electrode 42, the surface facing the liquid crystal layer 50, the elevated portions 45 formed in Embodiment 1 are not formed.

Cell gap d2 in the reflective region 17 is, for example, 1.7 μm. Cell gap d3 in the transmissive regions 16a and 16b is, for example, 3.4 μm. Distance d4 from a surface of the sub pixel electrodes 20a and 20b, the surface facing the liquid crystal layer 50, to a top surface of the elevated portion 77 is 2.2 μm or greater and 2.7 μm or less.

The elevated portions 79a, 79b and 79c, together with the elevated portion 77, act as alignment control means for aligning the liquid crystal molecules 51 in the transmissive region 16a, the transmissive region 16b and the reflective region 17 radially around the elevated portions 79a, 79b and 79c as the center. The elevated portions 79a, 79b and 79c also act as spacers for keeping the cell gap at a certain level.

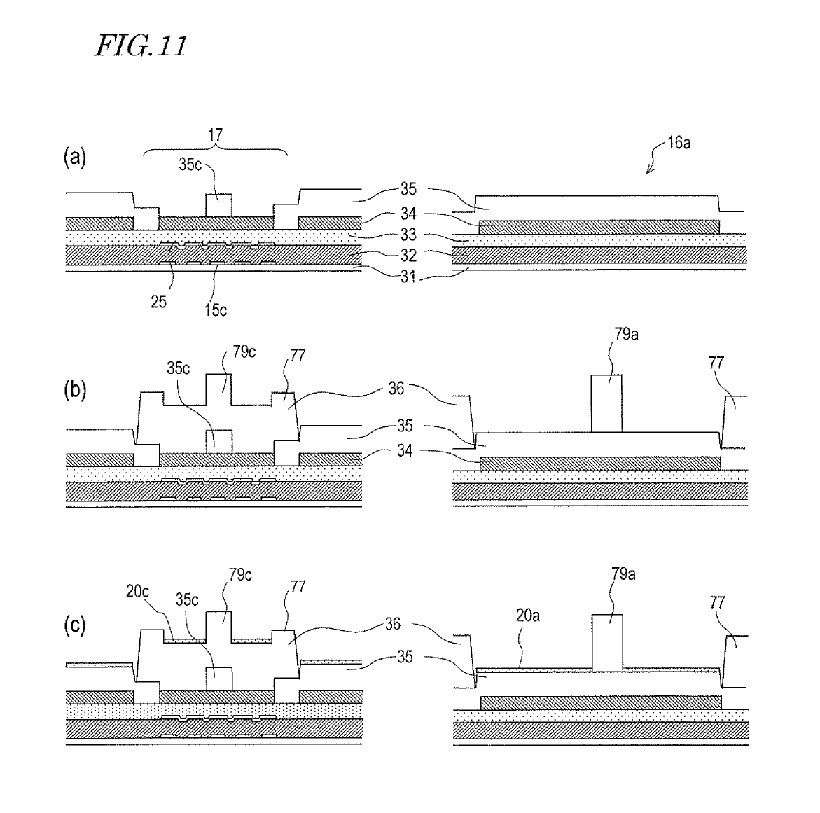

FIG. 10 provides views for explaining alignment of liquid crystal molecules 51 in the liquid crystal layer 50. FIGS. 10(a) and (b) respectively illustrate alignment of the liquid crystal molecules 51 in the reflective region 17 and the transmissive region 16a in the absence of a voltage between the pixel electrode 20 and the counter electrode 42. FIGS. 10(c) and (d) respectively illustrate alignment of the liquid crystal molecules 51 in the reflective region 17 and the transmissive region 16a in the presence of a voltage between the pixel electrode 20 and the counter electrode 42.

As shown in FIGS. 10(a) and (b), in the absence of a voltage, almost all the liquid crystal molecules 51 are aligned approximately vertical to the surfaces of the substrates by an action of alignment films (not shown) formed on the surfaces of the pixel electrode 20 and the counter electrode 42, the surfaces facing the liquid crystal layer 50. It should be noted, though, that the alignment films are also formed on a surface of the elevated portion 77, the surface being in contact with the liquid crystal layer 50, and on a side surface of the elevated portion 79, and so the liquid crystal molecules 51 in the vicinity of the elevated portions and 79 tend to be aligned vertical to these surfaces. Therefore, the liquid crystal molecules 51 in the vicinity of the elevated portions 77 and 79 are aligned to be inclined with respect to the surfaces of the substrates, and to be directed inward in each of the reflective region 17 and the transmissive regions 16a and 16b. Such an inclined alignment of the liquid crystal molecules 51 in the absence of a voltage will be referred to as the “pretilt”.

As shown in FIGS. 10(c) and (d), when the TFT 18 is turned on and a voltage is applied between the electrodes by the signal line 12, the liquid crystal molecules 51 are aligned to be inclined in a direction closer to a parallel direction to an equipotential surface, namely, in a direction closer to a parallel direction to the surfaces of the substrates. At this point, the liquid crystal molecules 51 are pulled by the orientation of the liquid crystal molecules 51 pretilted in the absence of a voltage and thus are aligned in each of the reflective region 17, the transmissive region 16a and the transmissive region 16b radially, approximately toward the center of the respective area (approximately toward the center of each of the elevated portions 79a, 79b and 79c) or from the center toward the outside of the respective area.

In this manner, the liquid crystal molecules 51 can be aligned more isotropically in a plane parallel to the surfaces of the substrates in each of the reflective region 17, the transmissive region 16a and the transmissive region 16b. Therefore, the viewing angle characteristics of display are improved. In addition, the orientation of the liquid crystal molecules 51 in the presence of a voltage is defined by the pretilt in the presence of a voltage. Therefore, the response speed of display is improved.

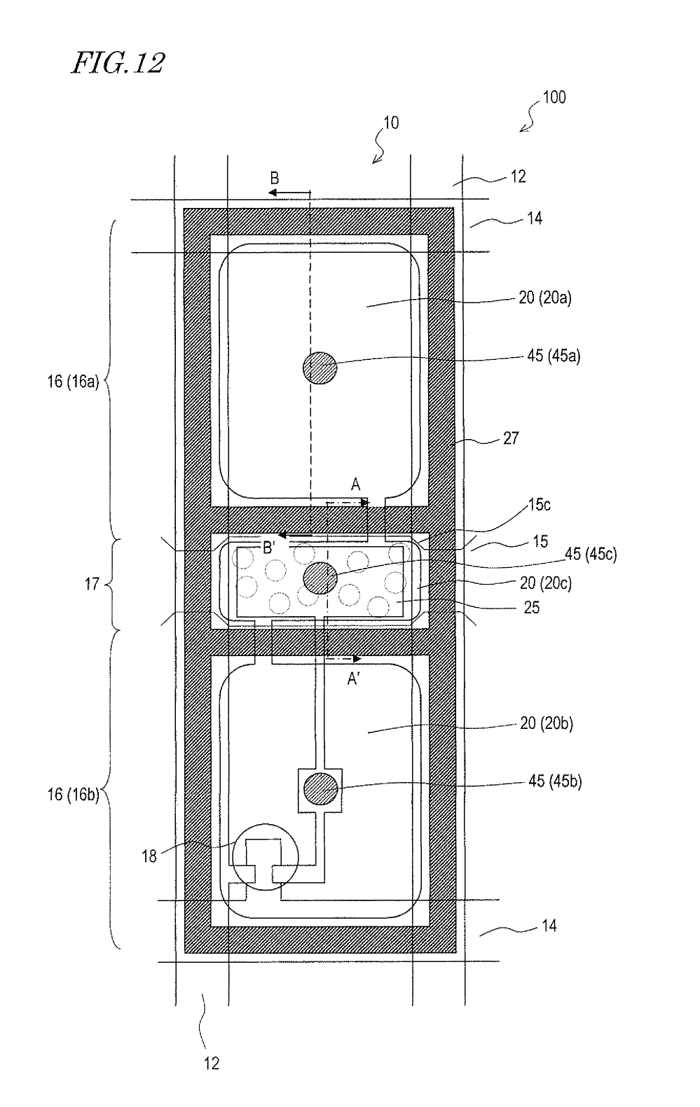

Now, with respect to FIG. 11, a method for producing the liquid crystal display device 102 will be described. FIGS. 11(a) through (c) are cross-sectional views showing a method for producing the TFT substrate 30 of the liquid crystal display device 102 and corresponds to FIGS. 6(f) through (h) regarding the production method in Embodiment 1. In FIG. 11, the cross-sectional view of the reflective region (corresponding to the A-A′ cross-section in FIG. 8) is shown on the left, and the cross-sectional view of the transmissive region 16a (corresponding to the B-B′ cross-section in FIG. 8) is shown on the right.

A first half of the steps for producing the TFT substrate 30 of the liquid crystal display device 102 (steps corresponding to FIGS. 6(a) through (e)) is the same as those described in Embodiment 1 and will not be described here. The steps for producing the counter substrate 40 are the same as those described in Embodiment 1 with reference to FIG. 7(a) (the production method excluding the step for forming the elevated portions 45) and will not be described here.

For producing the liquid crystal display device 102, after the color filters 34 of the TFT substrate 30 are formed, a transparent insulating resin is applied on the entire surface of the substrate by a spin-coater, a slit-coater or the like, and is heated at a temperature of 140° C. or lower. The transparent insulating resin used in this step is an acrylic resin having a negative photosensitivity. Next, the transparent insulating resin is subjected to proximity exposure using a seventh mask and developed using an alkaline developer of KOH or the like to form the transparent insulating layer 35 as shown in FIG. 11(a).

The transparent insulating layer 35 is formed on the color filter 34 in the transmissive regions 16, on areas between the transmissive regions 16 and the reflective region where the color filter 34 is not formed, and in the central portion of the reflective region 17. However, in the reflective region 17, the transparent insulating layer 35 is not formed except for on the central portion of the color filter 34.

In this step, a contact hole for electrically connecting the drain electrode of the TFT 18 to the layer thereabove is formed in the transparent insulating layer 35, above the contact hole formed in the color filter 34. In the contact hole, the protective layer 33 is exposed. Contact holes are also formed in at least an area where terminals are to be formed and an area where electrodes are to be connected. In these contact holes, the gate insulating layer 32 or the protective layer 33 is exposed. Next, dry etching is performed with a fluorine-based gas using the transparent insulating layer 35 as a mask to remove a part of the protective layer 33 and a part of the gate insulating layer 32 which are below the contact holes.

Next, a transparent acrylic resin is applied on the entire surface of the substrate by a spin-coater, a slit-coater or the like, and is heated at a temperature of 140° C. or lower. The transparent acrylic resin used in this step is an acrylic resin having a negative photosensitivity. The transparent acrylic resin is subjected to proximity exposure using an eighth mask and developed using an alkaline developer of KOH or the like to form the transparent resin layer 36 as shown in FIG. 11(b).

The transparent resin layer 36 is formed in the reflective region 17 or above the storage capacitance line 15 shown in FIG. 8, and extends in stripes in the left-right direction. The transparent resin layer 36 is formed on the color filter 34 in the reflective region 17, on areas between the transmissive regions 16 and the reflective region 17 where the color filter 34 is not formed, and in central portions of the transmissive regions 16a and 16b. However, the transparent resin layer 36 is not formed on the color filter 34 except for the central portions of the transmissive regions 16a and 16b. The projections 77 and 79c of the transparent resin layer 36 are formed by forming the transparent resin layer 36 on the transparent insulating layer 35. The projections 79a and 79b are formed of parts of the transparent resin layer 36 which are formed in the central portions of the transmissive regions 16a and 16b.

Next, ITO, which is a transparent oxide conductive material, is applied in a layer on the entire surface of the substrate to a thickness of 70 nm by a thin film formation technique such as sputtering or the like. Then, a resist mask having a prescribed pattern is formed using a ninth mask, and ITO is wet-etched with an oxalic acid-based etchant to obtain the pixel electrode 20 as shown in FIG. 11(c). After the pixel electrode 20 is formed, the substrate is heated at a temperature in the range of 150 to 230° C., preferably at a temperature of 200° C.

The sub pixel electrodes 20a, 20b and 20c included in the pixel electrode 20 are electrically connected to each other with a part of the pixel electrode 20. The sub pixel electrode 20b is electrically connected to the source electrode of the TFT 18 and the reflective layer (intermediate electrode) 25 via the contact holes. The pixel electrode 20 is not formed on any of the elevated portion 77, 79a, 79b and 79c. The elevated portion 77 is formed at the border between adjacent pixels 10 (an area between two adjacent pixel electrodes 20) and at the borders between the transmissive regions 16 and the reflective region 17, so as to surround each of the sub pixel electrodes 20a, 20b and 20c.

The liquid crystal display device 102 formed in this manner can stably align the liquid crystal molecules radially in each of the transmissive region 16a, the transmissive region 16b and the reflective region 17 by means of the elevated portions 77, 79a, 79b and 79c, and so can provide display with a high response speed and superb viewing angle characteristics. In addition, owing to ruggedness reflecting the shape of the storage capacitance electrode 15c which is formed in the reflective layer 25 in the reflection area 17, the liquid crystal display device 102 can reflect the reflected light diffusely and so can provide high viewing angle characteristics.

The production of the liquid crystal display device 102 requires masks of merely a number smaller than in the case of the liquid crystal display device 100 shown in FIG. 12 (nine masks in this embodiment), and so can be more efficient or simpler.

According to the present invention, the first elevated portion (corresponding to the elevated portion 77) is formed so as to surround the first sub pixel electrode (corresponding to the sub pixel electrode 20c) and the second sub pixel electrode (corresponding to the sub pixel electrode 20a or 20b). Therefore, the alignment of the liquid crystal can be regulated by the first elevated portion and so display with a high response speed and superb viewing angle characteristics can be provided.

The first elevated portion is formed as a part of the second transparent layer (corresponding to the transparent resin layer 36), and so a separate step of forming the first elevated portion is not necessary. Therefore, a liquid crystal display device providing a high response speed and superb viewing angle characteristics can be produced at a high production efficiency.

The first elevated portion is obtained by forming a part of the second transparent layer on the first transparent layer (corresponding to the transparent insulating layer 35), and so a special mask used exclusively for forming the first elevated portion is not necessary. Therefore, the production efficiency of the liquid crystal display device providing a high response speed and superb viewing angle characteristics can be improved.

The first elevated portion is formed by forming a part of the second transparent layer on a part of the first transparent layer, the part of the first transparent layer being formed in an opening or a hollow of the color filter layer (corresponding to the color filter 34). Therefore, the first elevated portion having an appropriate height can be obtained with a high production efficiency without using any special mask.

The alignment of the liquid crystal molecules can be controlled by the second elevated portion (corresponding to the elevated portion 45c), the third elevated portion (corresponding to the elevated portion 45a or 45b), the fourth elevated portion (corresponding to the elevated portion 79c), the fifth elevated portion (corresponding to the elevated portion 79a or 79b), the first central elevated portion (corresponding to the elevated portion 79c) and the second central elevated portion (corresponding to the elevated portion 79a or 79b). Therefore, display with a high response speed and superb viewing angle characteristics can be provided.

The fourth elevated portion, the fifth elevated portion, the first central elevated portion and the second central elevated portion are obtained by forming a part of the second transparent layer on the first transparent layer, and so a special mask used exclusively for forming these elevated portions is not necessary. Therefore, the production efficiency of the liquid crystal display device providing a high response speed and superb viewing angle characteristics can be improved.

### INDUSTRIAL APPLICABILITY

The present invention is preferably usable for various types of liquid crystal display devices including a TFT substrate.

### REFERENCE SIGNS LIST

10 Pixel

12 Signal line

14 Scanning line

15 Storage capacitance line

15c Storage capacitance electrode

16, 16a, 16c Transmissive region

17 Reflective region

18 TFT

20 Pixel electrode

20a, 20b, 20c Sub pixel electrode

25 Reflective layer (intermediate electrode)

27 Elevated portion (rib)

30 TFT substrate

31 Glass substrate

32 Gate insulating layer

33 Protective layer

34 Color filter

35 Transparent insulating layer (JAS)

36 Transparent resin layer

40 Counter substrate

41 Glass substrate

42 Counter electrode

45, 45a, 45b, 45c Elevated portion (rib)

50 Liquid crystal layer

51 Liquid crystal molecule

61 Scanning line driving circuit

62 Signal line driving circuit

63 Control circuit

66, 67 Polarizer plate

68 Backlight unit

77, 79 Elevated portion (rib)

100, 101, 102 Liquid crystal display device

1. A liquid crystal display device including a plurality of pixels each having a reflective region for providing display by reflecting light incident from a display plane side and a transmissive region for providing display by transmitting light incident from a side opposite to the display plane side, the liquid crystal display device comprising:
a TFT substrate including a TFT located for each of the plurality of pixels, a first transparent layer and a second transparent layer formed on the TFT, and a pixel electrode formed on the first transparent layer or the second transparent layer;
a counter substrate including a counter electrode facing the pixel electrode; and
a liquid crystal layer located between the TFT substrate and the counter substrate;
wherein:
the pixel electrode includes a first sub pixel electrode formed in the reflective region and a second sub pixel electrode formed in the transmissive region;
the first sub pixel electrode is formed on a surface of the second transparent layer, the surface facing the liquid crystal layer;
the second sub pixel electrode is formed on a surface of the first transparent layer, the surface facing the liquid crystal layer; and
the second transparent layer includes a first elevated portion which is formed to protrude toward the liquid crystal layer more than the first sub pixel electrode and to surround the first sub pixel electrode and the second sub pixel electrode.

2. The liquid crystal display device of claim 1, wherein:
the TFT substrate includes a plurality of scanning lines for supplying the TFT with a gate signal and a plurality of signal lines for supplying the TFT with a display signal;
the plurality of pixels are each located between two adjacent scanning lines among the plurality of scanning lines and two adjacent signal lines among the plurality of signal lines; and
the first elevated portion is formed on the two adjacent scanning lines, on the two adjacent signal lines, and in an area between the first sub pixel electrode and the second sub pixel electrode.

3. The liquid crystal display device of claim 1, wherein the first elevated portion is formed by the second transparent layer being stacked on the first transparent layer.

4. The liquid crystal display device of claim 1, comprising a protective layer formed on the TFT and a color filter layer formed on the protective layer; wherein:
the color filter layer has an opening or a hollow formed therein;
a part of the first transparent layer is formed in the opening or the hollow; and
the first elevated portion of the second transparent layer is formed above the opening or the hollow.

5. The liquid crystal display device of claim 1, wherein the first elevated portion has a height of 0.5 μm or greater and 1.0 μm or less from a surface of the first sub pixel electrode to a surface of the first elevated portion, the surface of the first elevated portion facing the counter substrate.

6. The liquid crystal display device of claim 1, wherein:
a second elevated portion reaching the TFT substrate is formed on a surface of the counter electrode in the reflective region; and
a third elevated portion extending toward the TFT substrate is formed on the surface of the counter electrode in the transmissive region.

7. The liquid crystal display device of claim 6, wherein the second elevated portion and the third elevated portion are respectively formed on centers of the first sub pixel electrode and the second sub pixel electrode.

8. The liquid crystal display device of claim 1, wherein:
the second transparent layer in the reflective region includes a fourth elevated portion reaching the counter electrode; and
the second transparent layer in the transmissive region includes a fifth elevated portion formed on the first transparent layer and reaching the counter substrate.

9. The liquid crystal display device of claim 8, wherein the fourth elevated portion is formed by the second transparent layer being formed on the first transparent layer.

10. The liquid crystal display device of claim 8, wherein the fourth elevated portion and the fifth elevated portion are respectively formed at central positions of the first sub pixel electrode and the second sub pixel electrode.

11. The liquid crystal display device of claim 1, wherein:
the TFT substrate includes a storage capacitance line extending to pass the reflective region, and a reflective layer located between the storage capacitance line and the first sub pixel electrode;
the pixel electrode and the reflective layer are electrically connected to each other; and
a storage capacitance is formed between the storage capacitance line and the reflective layer.

12. The liquid crystal display device of claim 11, wherein:
a part of the storage capacitance line, the part facing the reflective layer, has an opening or a hollow formed therein; and
ruggedness reflecting the opening or the hollow of the storage capacitance line is formed in the reflective layer.

13. The liquid crystal display device of claim 1, wherein the transmissive region includes a first transmissive region and a second transmissive region located so as to interpose the reflective region therebetween.

14. The liquid crystal display device of claim 1, wherein the liquid crystal layer is a vertical alignment type liquid crystal layer containing liquid crystal molecules having a negative dielectric anisotropy.

15. A method for producing a TFT substrate of a liquid crystal display device including a plurality of pixels each having a reflective region for providing display by reflecting light incident from a display plane side and a transmissive region for providing display by transmitting light incident from a side opposite to the display plane side, the method comprising:
a first step of forming a TFT for each of the plurality of pixels;
a second step of forming a first transparent layer after the first step;
a third step of forming a second transparent layer after the second step; and
a fourth step of forming a pixel electrode on the first transparent layer and the second transparent layer after the third step;
wherein:
in the third step, a first elevated portion extending to surround each of the reflective region and the transmissive region is formed in the second transmissive layer; and
the fourth step includes a step of forming a first sub pixel electrode on the second transparent layer in the reflective region and a step of forming a second sub pixel electrode on the first transparent layer in the transmissive layer, and the first sub pixel electrode and the second sub pixel electrode are each formed to be surrounded by the first elevated portion.

16. The method of claim 15, further comprising a step of forming a plurality of scanning lines for supplying the TFT with a gate signal and a step of forming a plurality of signal lines for supplying the TFT with a display signal; wherein:
the plurality of pixels are each located between two adjacent scanning lines among the plurality of scanning lines and two adjacent signal lines among the plurality of signal lines; and
in the third step, the first elevated portion is formed on the two adjacent scanning lines, on the two adjacent signal lines, and in an area between the reflective region and the transmissive region.

17. The method of claim 15 or 16, wherein in the third step, the first elevated portion is formed by stacking the second transparent layer on the first transparent layer.

18. The method of claim 1, further comprising a step of forming a protective layer on the TFT and a step of forming a color filter having an opening or a hollow on the protective layer; wherein:
in the second step, a part of the first transparent layer is formed in the opening or the hollow; and
in the third step, the first elevated portion is formed by forming a part of the second transparent layer on the part of the first transparent layer.

19. The method of claim 15, wherein in the third step, a first central elevated portion protruding more than the first elevated portion in a central portion of the reflective region and a second central elevated portion protruding more than the first elevated portion in a central portion of the transmissive region are formed in the second transparent layer.

20. The method of claim 19, wherein in the third step, the first central elevated portion and the second central elevated portion are formed by forming the second transparent layer on the first transparent layer.

21. The method of claim 16, wherein:
in the step of forming the scanning lines, a storage capacitance line extending to pass the reflective region is formed; and
in the step of forming the signal lines, a reflective layer is formed on the storage capacitance line.

22. The method of claim 21, wherein:
an opening or a hollow is formed in a part of the storage capacitance line; and
ruggedness reflecting the opening or the hollow of the storage capacitance line is formed in the reflective layer.

23. The method of claim 1, wherein the TFT substrate is formed using nine photomasks.
